(19) United States
(12) Patent Application Publication
(10) Pub. No.: US 2026/0023810 A1
(43) Pub. Date: Jan. 22, 2026

(54) PROBLEM SOLVING DEVICE, PROBLEM SOLVING METHOD, AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventor: Masaru SUZUKI, Ota Tokyo (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 19/222,208

(22) Filed: May 29, 2025

(30) Foreign Application Priority Data
Jul. 22, 2024 (JP) 2024-116930

(51) Int. Cl. G06F 17/12; G06F 17/16

(52) U.S. Cl. CPC G06F 17/12; G06F 17/16

(57) ABSTRACT

A problem solving device generates a trunk instance and M branch instances by exclusively dividing each of multiple terms in a main problem objective function and a main problem constraint set. The trunk instance includes a trunk objective function and a trunk constraint set. Each M branch instance includes a branch objective function and a branch constraint set. A processing unit generates a common decision variable set including decision variables commonly used for two instances. The processing unit generates, for each M branch instance, a branch candidate vector representing a solution minimizing the branch objective function, under constraints fixing values of the decision variables in the common decision variable set to values included in a common candidate vector. The processing unit outputs a main problem solution vector including a trunk candidate vector and the branch candidate vector for each M branch decision variable.

### CROSS-REFERENCE TO RELATED APPLICATIONS

This application is based upon and claims the benefit of priority from Japanese Patent Application No. 2024-116930, filed on Jul. 22, 2024; the entire contents of which are incorporated herein by reference.

### FIELD

Embodiments described herein relate generally to a problem solving device, a problem solving method, and a computer program product.

### BACKGROUND

In optimization problems in the real world, a main problem often includes subproblems. There are many cases where a main problem requiring a huge amount of computation time when the entirety is optimized at one time can be optimized in a realistic amount of computation time by using the structure of subproblems. However, discovering the structure of the subproblems from the main problem is difficult, and there are many cases where an appropriate solution is not obtainable when the main problem is solved without using the structure of the subproblems. As such, a method is required to properly discover the structure of the subproblems from the main problem.

As the main problem including the structure of the subproblems, for example, there is a problem of searching for a route that minimizes the time to travel by a vehicle between two specific points. For example, when searching for a route from a first point in a first city to a second point in a second city, when all roads from the first point to the second point are considered in the search, a huge amount of computation time is required.

A first algorithm considering the subproblem structure of a road network is thinkable for a method of solving such problems.

The first algorithm first searches for a route that minimizes the time to travel by a vehicle from the first point to several highway entrances around the first point. The first algorithm secondly searches for a route that minimizes the time to travel by the vehicle from the several highway entrances around the first point to several highway exits around the second point. The first algorithm thirdly searches for a route that minimizes the time to travel by the vehicle from the several highway exits around the second point to the second point. The first algorithm fourthly searches for combinations that minimize the time to travel by the vehicle for the several highway entrances around the first point and the several highway exits around the second point. Such a first algorithm can search for the main problem of searching for a route that minimizes the time to travel by a vehicle between two specific points, in a realistic amount of computation time.

A method for reducing the time for solving linear programming problems with a large problem size by the following second algorithm is also known.

The second algorithm first decides the division granularity of the linear programming problem on the basis of the allowable time required to solve the linear programming problem to be solved. The second algorithm secondly prepares an objective function for each subproblem to be divided from the linear programming problem from an objective function of the linear programming problem on the basis of the decided division granularity. The second algorithm thirdly prepares a constraint equation for each subproblem on the basis of a set of constraint equations for the linear programming problem and past assignment result data for variables included in the linear programming problem. The second algorithm fourthly calculates a solution to the linear programming problem by solving each subproblem in order on the basis of the objective function and the constraint equation prepared for each subproblem.

Such a second algorithm envisions solving a date-based nurse scheduling problem (NSP). NSP is a problem of preparing a schedule that satisfies nurses' workload and vacation preferences by assigning a required number of nurses with a required skill level to duty hours (shift) assuming two or three shifts.

Typical constraint conditions in NSP are categorized into the following three types.

The first type is a constraint condition that the required number of nurses with a required skill level are assigned to each shift. The second type is a constraint condition that the workload is calculated for each nurse over a range of a predetermined number of consecutive shifts or a predetermined number of days and the calculated workload is kept within a predetermined range. The third type is a constraint condition that vacation is assigned to a specific date and time for each nurse.

For example, one month's NSP includes subproblems for week 1, week 2, week 3, and week 4. When a connection between two subproblems is evaluated by the number of constraint conditions that span the two subproblems, the connection is strong for the combinations of week 1 and week 2, week 2 and week 3, and week 3 and week 4, and becomes weaker as time moves away. In addition, for one month's NSP, shift not subjected to optimization exists before week 1. For the one month's NSP, shifts not subjected to optimization also serve as a constraint condition.

The second algorithm uses such a structure of subproblems to solve NSP as follows. The second algorithm first optimizes subproblems for week 1. The second algorithm secondly optimizes subproblems for week 2 by fixing variables belonging to week 1. The second algorithm thirdly optimizes subproblems for week 3 by fixing variables belonging to weeks 1 and 2. The second algorithm thirdly optimizes subproblems for week 4 by fixing variables belonging to weeks 1, 2, and 3. This allows the second algorithm to reduce NSP computation time while maintaining solution accuracy.

A method for reducing the time for solving linear programming problems with a large problem size by the following third algorithm is also known.

The third algorithm solves a workflow schedule problem (WSP) as follows. The third algorithm first extracts m jobs from the upstream of dependency relation among jobs that have not yet decided a time slot for execution. The third algorithm secondly extracts, from the beginning in time, n time slots from time slots with sufficient remaining resources. The third algorithm thirdly optimizes subproblems with the m jobs and the n time slots. The third algorithm fourthly decides a time slot to run for optimized jobs, reduces the amount of resources for the time slot, and returns to the first process.

A typical job shop scheduling problem (JSP) includes several ordered sequences that need to be processed in order of Job A, Job B, and Job C, for example. The typical JSP sets the amount of resources and processing time required for each job. Subsequently, the JSP optimizes the order of job execution to the extent that the amount of resources required for jobs that can be simultaneously executed does not exceed the upper limit of the amount of resources. The third algorithm reduces the computation time while maintaining solution accuracy by a method of repeatedly solving subproblems of such JSP with m jobs and n time slots extracted from the front of the ordered sequence.

Unlike JSP, the workflow scheduling problem (WSP) is a directed acyclic graph of dependency relation among jobs. The third algorithm solves subproblems of such WSP with m jobs and n time slots extracted from the upstream of the dependency relation, which is more complex than solving JSP being a simple ordered sequence, but reduces the computation time while maintaining solution accuracy.

As described above, the second algorithm targets problems where the assumed problem class is NSP and a natural total order of date and time exists. Therefore, the second algorithm can reduce the computation time while maintaining solution accuracy by extracting the subproblems in order from the front for the total order of date and time.

On the other hand, the third algorithm targets problems where the assumed problem class is WSP and a natural partial order of dependency relation exists. Therefore, the third algorithm obtains the total order by performing a topological sort on the partial order by dependency relation. Subsequently, the third algorithm reduces the computation time while maintaining solution accuracy by extracting the subproblems in order from the front for the total order of the topological sorting results.

As described above, when the natural total order or partial order exists in the problem class, using a heuristic solution utilizing the total order or partial order is effective, as in the second algorithm and the third algorithm.

However, the second algorithm and the third algorithm have the problem that obtaining highly accurate solutions is difficult for problem classes including no natural total order or partial order but including the structure of subproblems. In addition, the second algorithm targets only linear programming problems and is not able to solve quadratic and nonlinear programming problems.

### BRIEF DESCRIPTION OF THE DRAWINGS

FIG. 1 is a functional configuration diagram of a problem solving device according to a first embodiment;

FIG. 2 is a diagram illustrating information stored in a storage device;

FIG. 3 is a diagram illustrating information stored in a memory;

FIG. 4 is a diagram illustrating the relationship between instances;

FIG. 5 is a diagram illustrating a vector;

FIG. 6 is a diagram illustrating the process flow of the problem solving device;

FIG. 7 is a flowchart indicating the flow of a main process;

FIG. 8 is a flowchart indicating the flow of a division process at S14;

FIG. 9 is a diagram illustrating an undirected graph;

FIG. 10 is a diagram illustrating a clustered undirected graph;

FIG. 11 is a diagram illustrating an undirected graph with some of nodes removed;

FIG. 12 is a diagram illustrating the relationship between the undirected graph and instances;

FIG. 13 is a flowchart indicating the flow of a process of generating vectors at S19;

FIG. 14 is a flowchart indicating the flow of a solving process at S20;

FIG. 15 is a flowchart indicating the flow of an acceptance determination process at S22;

FIG. 16 is a diagram illustrating an undirected graph in a problem solving example;

FIG. 17 is a diagram illustrating a set of edges in the undirected graph in the problem solving example;

FIG. 18 is a diagram illustrating an example of a main problem latest vector;

FIG. 19 is a diagram illustrating an example of a common candidate vector;

FIG. 20 is a diagram illustrating an example of a branch candidate vector corresponding to a first branch instance;

FIG. 21 is a diagram illustrating an example of a branch candidate vector corresponding to a second branch instance;

FIG. 22 is a diagram illustrating an example of a main problem solution vector;

FIG. 23 is a configuration diagram of a problem solving system according to a second embodiment;

FIG. 24 is a flowchart indicating the flow of a division process in a third embodiment; and

FIG. 25 is a flowchart indicating the flow of a division process in a fourth embodiment.

### DETAILED DESCRIPTION

The problem to be solved by the present disclosure is to calculate a solution to a problem of minimizing an objective function including a huge number of decision variables in a realistic amount of time.

In general, according to an embodiment, a problem solving device that calculates a main problem solution vector representing a solution that minimizes a main problem objective function being a polynomial obtained by adding up multiple terms, under constraints imposed by constraint conditions included in a main problem constraint set includes a processing unit including a hardware processor. Where each of the multiple terms is an equation obtained by multiplying one or more of multiple decision variables by a coefficient. The processing unit acquires a main problem instance including the main problem objective function and the main problem constraint set. The processing unit generates a trunk instance and M branch instances (M is an integer equal to or greater than 2) by exclusively dividing each of the multiple terms included in the main problem objective function and the main problem constraint set. The trunk instance includes a trunk objective function being an equation obtained by adding up some of the multiple terms and a trunk constraint set being a subset of the main problem constraint set. Each of the M branch instances includes a branch objective function being an equation obtained by adding up some of the multiple terms and a branch constraint set being a subset of the main problem constraint set. The processing unit generates a common decision variable set including decision variables commonly used for the trunk instance and any two of the M branch instances. The processing unit generates a trunk candidate vector representing values of the decision variables included in the trunk instance and a common candidate vector representing values of the decision variables included in the common decision variable set. The processing unit generates, for each of the M branch instances, a branch candidate vector representing a solution that minimizes the branch objective function, under constraints imposed by constraint conditions included in the branch constraint set and constraints that fix the values of the decision variables included in the common decision variable set to values included in the common candidate vector. The processing unit outputs the main problem solution vector including the trunk candidate vector and the branch candidate vector for each of the M branch instances.

Exemplary embodiments of a problem solving device, a problem solving method, and a computer program product will be explained below in detail with reference to the accompanying drawings. The present disclosure is not limited to the following embodiments.

### FIRST EMBODIMENT

First, a problem solving device 1 according to a first embodiment is described. The problem solving device 1 calculates a solution to a problem of minimizing an objective function including a huge number of decision variables in a realistic amount of time under constraints imposed by constraint conditions. The problem to be solved by the problem solving device 1 may be not only a linear programming problem, but also a quadratic programming problem, a nonlinear programming problem, or the like.

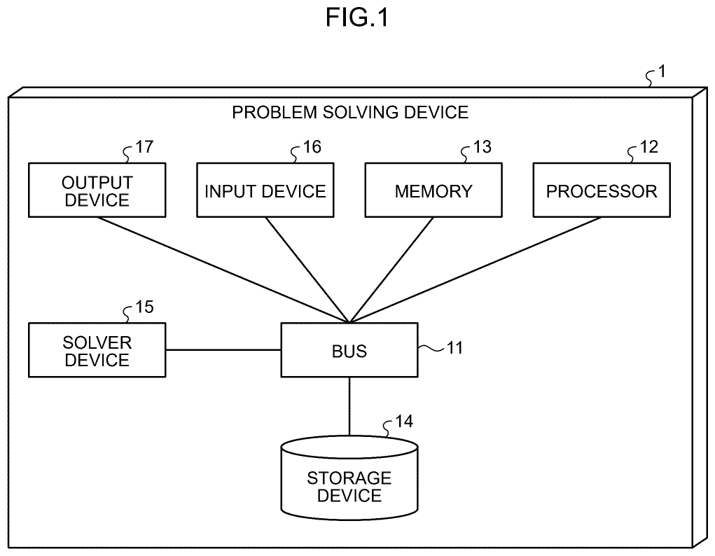

FIG. 1 is a diagram illustrating the functional configuration of the problem solving device 1 according to the first embodiment.

The problem solving device 1 includes a bus 11, a processor 12, a memory 13, a storage device 14, a solver device 15, an input device 16, and an output device 17. The processor 12, the memory 13, the storage device 14, the solver device 15, the input device 16, and the output device 17 are connected to one another via the bus 11.

The memory 13 and the storage device 14 store therein information. The processor 12 is a central processing unit (CPU) or the like, and is a processing unit that performs processing according to a computer program. The input device 16 acquires information from users or other devices. The output device 17 outputs information to users or other devices. The output device 17 is, for example, a display device.

The solver device 15 performs a solving process of finding a solution to a problem of minimizing an objective function under constraint conditions. The solver device 15 may be implemented by the processor 12, rather than by circuitry or a device separate from the processor 12.

The solver device 15 may also be implemented by a CPU, by a graphics processing unit (GPU), or by a reconfigurable semiconductor device such as a field-programmable gate array (FPGA). The solver device 15 may also be implemented by an accelerator, an application specific integrated circuit (ASIC), or electronic circuitry including these circuits. The solver device 15 may also be implemented by an information processing device such as a computer, a computer system including multiple computers or servers communicating with one another via a network, a PC cluster including multiple computers that perform information processing in cooperation with one another, or the like.

The solver device 15 uses a heuristic solution algorithm to find an approximate solution by solving the problem of minimizing the objective function under the constraint conditions. This allows the solver device 15 to output multiple solutions that minimize the objective function under the constraint conditions.

The solver device 15 may be any device capable of obtaining the solution to the problem of minimizing the objective function under the constraint conditions. For example, the solver device 15 may be a device using a quantum annealing technology or a pseudo-quantum annealing technology.

In the present embodiment, the solver device 15 solves the problem by using a simulated bifurcation algorithm. The simulated bifurcation algorithm is disclosed in, for example, Hayato Goto, Kosuke Tatsumura and Alexander R. Dixon, “Combinatorial optimization by simulating adiabatic bifurcations in nonlinear Hamiltonian systems,” Science Advances 5, eaav2372, 2019, and Hayato Goto, Kotaro Endo, Masaru Suzuki, Yoshisato Sakai, Taro Kanao, Yohei Hamakawa, Ryo Hidaka, Masaya Yamasaki and Kosuke Tatsumura, “High-performance combinatorial optimization based on classical mechanics,” Science Advances 7, eabe7953, 2021, and Japanese Patent Application Laid-open No. 2021-043667 and Japanese Patent Application Laid-open No. 2021-043589. The simulated bifurcation algorithm is also called a quantum-inspired algorithm because it was discovered by being inspired by a quantum mechanical optimization method based on a quantum adiabatic theorem. The simulated bifurcation algorithm can solve combinatorial optimization problems, that is, QUBO problems, where a cost function is a quadratic function of multiple binary decision variables. The simulated bifurcation algorithm can also solve combinatorial optimization problems, that is, higher order binary optimization (HUBO) problems, where the cost function is a cubic or higher function of multiple binary decision variables. The simulated bifurcation algorithm for solving the HUBO problem is disclosed in, for example, Japanese Patent Application Laid-open No. 2021-043667. The simulated bifurcation algorithm can also solve combinatorial optimization problems including continuous-valued variables in some or all of the multiple decision variables. The simulated bifurcation algorithms for solving the combinatorial optimization problems including the continuous-valued variables in some or all of the multiple decision variables are disclosed in, for example, Japanese Patent Application Laid-open No. 2021-043589.

In the present embodiment, the solver device 15includes multiple engines that each independently output a solution to a problem. The solver device 15 outputs a solution to each of given multiple problems by running the multiple engines in parallel. The solver device 15 may output the solution to each of the multiple problems, with one engine performing the process in multiple iterations.

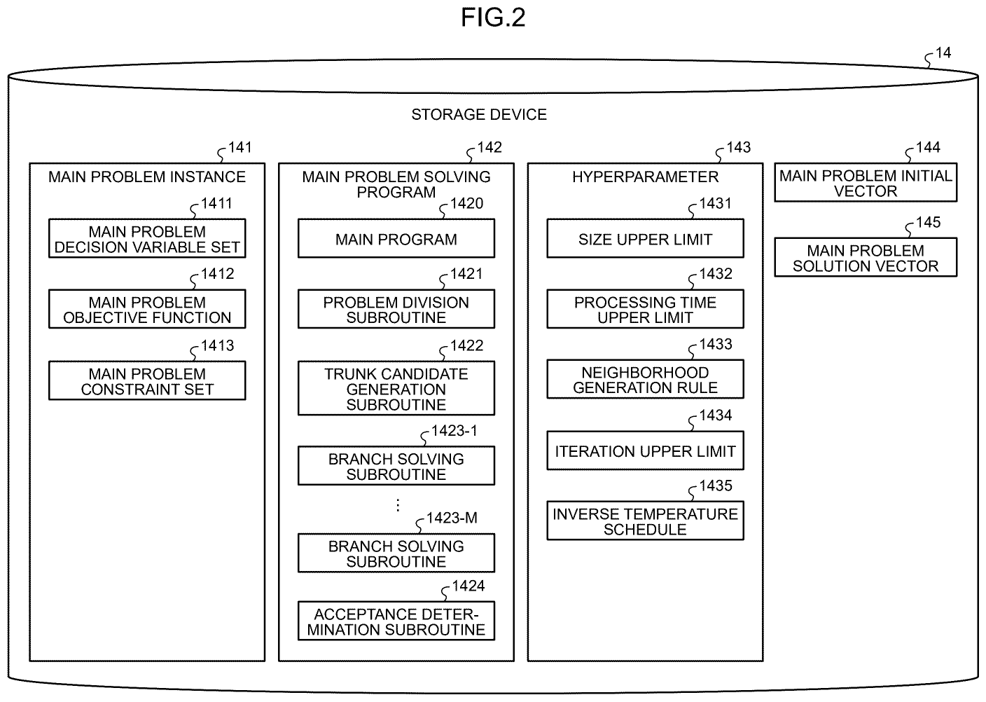

FIG. 2 is a diagram illustrating the information stored in the storage device 14. The storage device 14 stores therein a main problem instance 141, a main problem solving program 142, a hyperparameter 143, a main problem initial vector 144, and a main problem solution vector 145.

The main problem instance 141 includes a main problem decision variable set 1411, a main problem objective function 1412, and a main problem constraint set 1413.

The main problem solving program 142 includes a main program 1420, a problem division subroutine 1421, a trunk candidate generation subroutine 1422, M branch solving subroutines 1423-1, 1423-2, . . . , 1423-M, and an acceptance determination subroutine 1424. M is an integer equal to or greater than 2.

The main program 1420 is a computer program executed by the processor 12. The problem division subroutine 1421, the trunk candidate generation subroutine 1422, the M branch solving subroutine 1423-1, 1423-2, . . . , 1423-M, and the acceptance determination subroutine 1424 are subroutine programs called by the processor 12 during the execution of the main program 1420 and executed by the processor 12.

The hyperparameter 143 is a value or information referenced by the processor 12. The hyperparameter 143 includes a size upper limit 1431, a processing time upper limit 1432, a neighborhood generation rule 1433, an iteration upper limit 1434, and an inverse temperature schedule 1435.

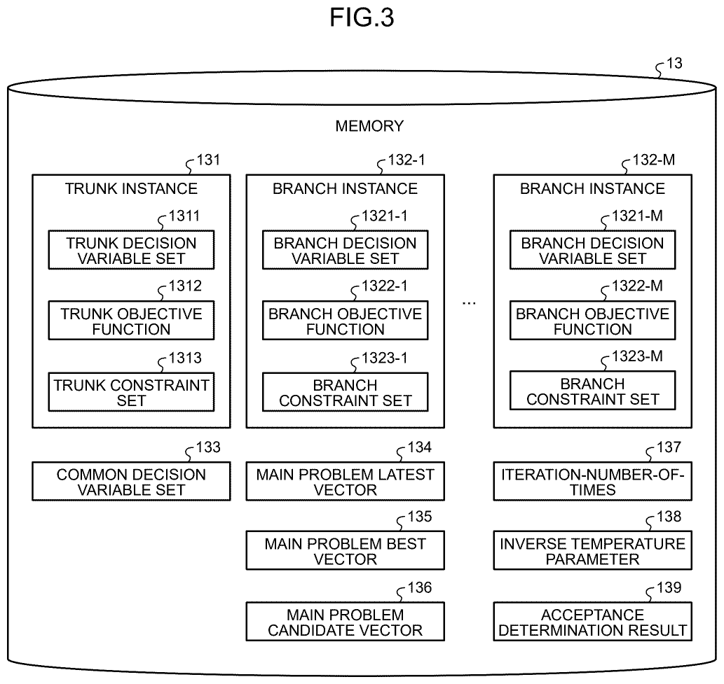

FIG. 3 is a diagram illustrating the information stored in the memory 13. The memory 13 stores therein a trunk instance 131, M branch instances 132-1, 132-2, . . . , 132-M, a common decision variable set 133, a main problem latest vector 134, a main problem best vector 135, a main problem candidate vector 136, an iteration-number-of-times 137, an inverse temperature parameter 138, and an acceptance determination result 139.

The trunk instance 131 includes a trunk decision variable set 1311, a trunk objective function 1312, and a trunk constraint set 1313.

The m^{th} (m-th) branch instance 132-m (m is an integer equal to and greater than 1 and M or smaller) of the M branch instances 132-1, 132-2, . . . , 132-M includes a branch decision variable set 1321-m, a branch objective function 1322-m, and a branch constraint set 1323-m.

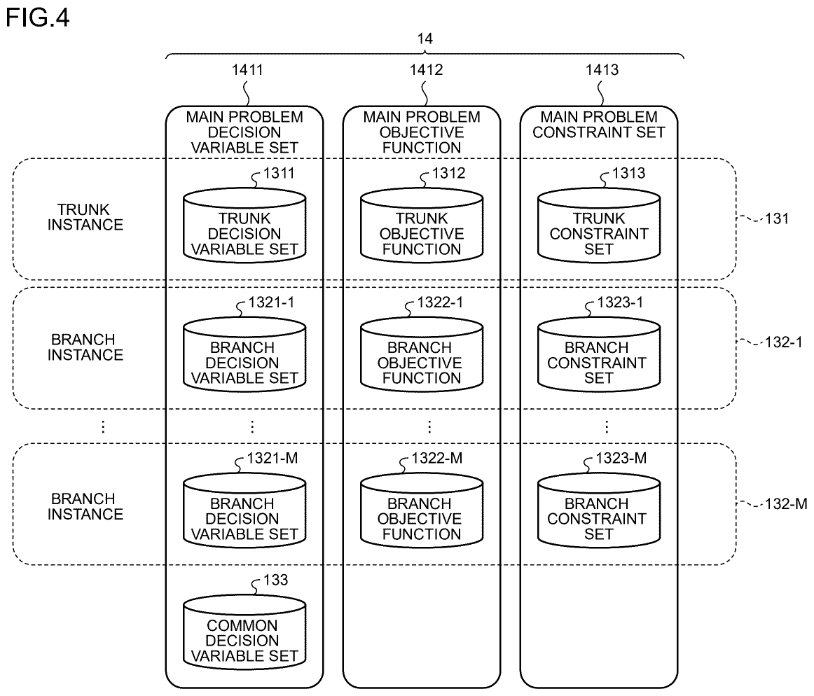

FIG. 4 is a diagram illustrating the relationship among the main problem instance 141, the trunk instance 131, the M branch instances 132-1, 132-2, . . . , 132-M, and the common decision variable set 133.

The main problem decision variable set 1411 is a set including multiple decision variables included in the main problem objective function 1412. The main problem objective function 1412 is a polynomial obtained by adding up multiple terms. Each of the multiple terms included in the main problem objective function 1412 is an equation obtained by multiplying one or more of the multiple decision variables included in the main problem decision variable set 1411 by a coefficient.

The main problem constraint set 1413 includes constraint conditions. The main problem constraint set 1413 may include two or more constraint conditions, or may be an empty set. The constraint conditions are equations or inequalities using some of the multiple decision variables included in the main problem decision variable set 1411.

The m^{th} branch instance 132-m of the M branch instances 132-1, 132-2, . . . , 132-M includes the branch decision variable set 1321-m, the branch objective function 1322-m, and the branch constraint set 1323-m.

The branch decision variable set 1321-m is a subset of the main problem decision variable set 1411. That is, the branch decision variable set 1321-m includes some of the multiple decision variables included in the main problem decision variable set 1411.

However, two or more decision variables included in the branch decision variable set 1321-m of the m^{th} branch instance 132-m do not overlap two or more decision variables included in the branch decision variable set 1321 other than the m^{th} branch instance 132-m. That is, the branch decision variable set 1321-m of the m^{th} branch instance 132-m includes decision variables not included in the branch decision variable set 1321 of the branch instance 132 different from the m^{th} branch instance 132-m. That is, the branch decision variable set 1321 in each of the M branch instances 132-1, 132-2, . . . , 132-M exclusively includes two or more decision variables.

The branch objective function 1322-m is an equation obtained by adding up some of the multiple terms included in the main problem objective function 1412. Terms included in the branch objective function 1322-m include at least one decision variable included in the branch decision variable set 1321-m.

However, the terms included in the branch objective function 1322-m of the m^{th} branch instance 132-m do not overlap terms included in the branch objective function 1322 other than the m^{th} branch instance 132-m. That is, the branch objective function 1322-m of the m^{th} branch instance 132-m includes terms not included in the branch objective function 1322 of the branch instance 132 different than the m^{th} branch instance 132-m. That is, the branch objective function 1322-m in each of the M branch instances 132-1, 132-2, . . . , 132-M includes exclusively terms.

The branch constraint set 1323-m is a subset of the main problem constraint set 1413. That is, the branch constraint set 1323-m includes some of the constraint conditions of the main problem constraint set 1413. The branch constraint set 1323-m may be an empty set. The constraint conditions included in the branch constraint set 1323-m include at least one decision variable included in the branch decision variable set 1321-m.

However, the constraint conditions included in the branch constraint set 1323-m of the m^{th} branch instance 132-m do not overlap constraint conditions included in the branch constraint set 1323 other than the m^{th} branch instance 132-m. That is, the branch constraint set 1323-m of the m^{th} branch instance 132-m includes constraint conditions not included in the branch constraint set 1323 of the branch instance 132 different than the m^{th} branch instance 132-m. That is, the branch constraint set 1323 in each of the M branch instances 132-1, 132-2, . . . , 132-M includes exclusively constraint conditions.

The common decision variable set 133 includes decision variables that are commonly used for the trunk instance 131 and any two of the M branch instances 132-1, 132-2, . . . , 132-M.

For example, multiple decision variables included in the branch objective function 1322 and the branch constraint set 1323 for all the M branch instances 132-1, 132-2, . . . , 132-M are set as a first set. Multiple decision variables included in the branch decision variable set 1321 for all the M branch instances 132-1, 132-2, . . . , 132-M are set as a second set. In this case, the common decision variable set 133 includes decision variables not included in the second set of the first set. That is, the common decision variable set 133 is a set obtained by excluding the second set from the first set.

The trunk instance 131 includes the trunk decision variable set 1311, the trunk objective function 1312, and the trunk constraint set 1313.

The trunk decision variable set 1311 is a subset of the main problem decision variable set 1411. That is, the trunk decision variable set 1311 includes some of the multiple decision variables included in the main problem decision variable set 1411. The trunk decision variable set 1311 may be an empty set.

However, the decision variables included in the trunk decision variable set 1311 do not overlap decision variables included in any of the branch decision variable sets 1321 in the M branch instances 132-1, 132-2, . . . , 132-M, and the common decision variable set 133. That is, the trunk decision variable set 1311 includes decision variables excluding the decision variables included in the common decision variable set 133 and the branch decision variable set 1321 of each of the M branch instances 132-1, 132-2, . . . , 132-M from the decision variables of the main problem decision variable set 1411.

That is, the trunk decision variable set 1311, the branch decision variable set 1321 in each of the M branch instances 132-1, 132-2, . . . , 132-M, and the common decision variable set 133 exclusively include decision variables. A set obtained by adding up the trunk decision variable set 1311, the branch decision variable set 1321 in each of the M branch instances 132-1, 132-2, . . . , 132-M, and the common decision variable set 133 serves as the main problem decision variable set 1411.

The trunk objective function 1312 is an equation obtained by adding up some of the multiple terms included in the main problem objective function 1412. The trunk objective function 1312 may be zero. The terms included in the trunk objective function 1312 include at least one decision variable included in the trunk decision variable set 1311.

However, the terms included in the trunk objective function 1312 do not also overlap the terms in any of the branch objective functions 1322 in the M branch instances 132-1, 132-2, . . . , 132-M. That is, the trunk objective function 1312 includes terms excluding the terms included in the branch objective function 1322 of each of the M branch instances 132 from the multiple terms included in the main problem objective function 1412. That is, the trunk objective function 1312 and the branch objective function 1322 of the M branch instances 132-1, 132-2, . . . , 132-M include exclusively terms.

The trunk constraint set 1313 is a subset of the main problem constraint set 1413. That is, the trunk constraint set 1313 includes some of the constraint conditions in the main problem constraint set 1413. The trunk constraint set 1313 may be an empty set.

However, the constraint conditions included in the trunk constraint set 1313 do not also overlap the constraint conditions included in any of the branch constraint sets 1323 in the M branch instances 132-1, 132-2, . . . , 132-M. That is, the trunk constraint set 1313 includes constraint conditions excluding the constraint conditions included in the branch constraint set 1323 of each of the M branch instances 132-1, 132-2, . . . , 132-M from the constraint conditions of the main problem constraint set 1413. That is, the trunk constraint set 1313 and the branch constraint sets 1323 of the M branch instances 132-1, 132-2, . . . , 132-M include exclusively constraint conditions.

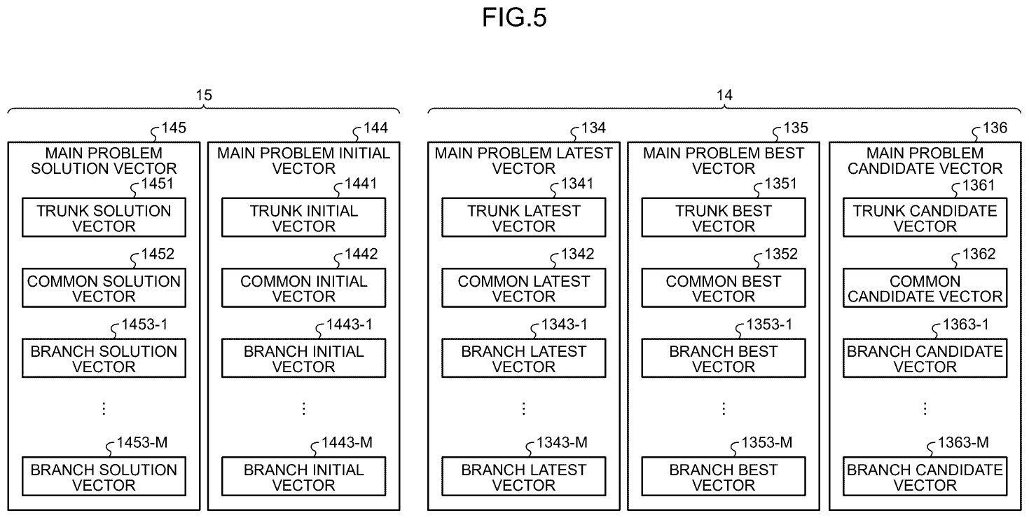

FIG. 5 is a diagram illustrating the main problem solution vector 145, the main problem initial vector 144, the main problem latest vector 134, the main problem best vector 135, and the main problem candidate vector 136.

The main problem solution vector 145 represents the solutions of the multiple decision variables that minimize the main problem objective function 1412 under the constraints imposed by the constraint conditions included in the main problem constraint set 1413.

The main problem solution vector 145 includes a trunk solution vector 1451, a common solution vector 1452, and M branch solution vectors 1453-1, 1453-2, . . . , 1453-M. The trunk solution vector 1451 represents the values of the decision variables included in the trunk decision variable set 1311 among the solutions of the multiple decision variables. The common solution vector 1452 represents the values of the decision variables included in the common decision variable set 133 among the solutions of the multiple decision variables. The m^{th} branch solution vector 1453-m of the M branch solution vectors 1453-1, 1453-2, . . . , 1453-M represents the values of the decision variables included in the branch decision variable set 1321-m in the m^{th} branch instance 132-m among the solutions of the multiple decision variables.

The main problem initial vector 144 represents the initial values of the multiple decision variables included in the main problem decision variable set 1411, which satisfy the constraint conditions included in the main problem constraint set 1413.

The main problem initial vector 144 includes a trunk initial vector 1441, a common initial vector 1442, and M branch initial vectors 1443-1, 1443-2, . . . , 1443-M. The trunk initial vector 1441 represents the values of the decision variables included in the trunk decision variable set 1311 among the initial values of the multiple decision variables. The common initial vector 1442 represents the values of the decision variables included in the common decision variable set 133 among the initial values of the multiple decision variables. The m^{th} branch initial vector 1443-m of the M branch initial vectors 1443-1, 1443-2, . . . 1443-M represents the value of the decision variable included in the branch decision variable set 1321-m at the m^{th} branch instance 132-m among the initial values of the multiple decision variables.

The main problem candidate vector 136 represents the candidate values of the solutions of the multiple decision variables that minimize the main problem objective function 1412 under the constraints imposed by the constraint conditions included in the main problem constraint set 1413.

The main problem candidate vector 136 includes a trunk candidate vector 1361, a common candidate vector 1362, and M branch candidate vectors 1363-1, 1363-2, . . . , 1363-M. The trunk candidate vector 1361 represents the values of the decision variables included in the trunk decision variable set 1311 among the candidate values of the multiple decision variables. The common candidate vector 1362 represents the values of the decision variables included in the common decision variable set 133 among the candidate values of the multiple decision variables. The m^{th} branch candidate vector 1363-m of the M candidate vectors 1363-1, 1363-2, . . . , 1363-M represents the values of the decision variables included in the branch decision variable set 1321-m at the m^{th} branch instance 132-m.

The main problem latest vector 134 is the latest main problem candidate vector 136 of the main problem candidate vectors 136 that are generated in multiple iterations.

The main problem latest vector 134 includes a trunk latest vector 1341, a common latest vector 1342, and M branch latest vectors 1343-1, 1343-2, . . . , 1343-M. The trunk latest vector 1341 represents the values of the decision variables included in the trunk decision variable set 1311 among the latest values of the multiple decision variables. The common latest vector 1342 represents the values of the decision variables included in the common decision variable set 133 among the latest values of the multiple decision variables. The m^{th} branch latest vector 1343-m of the M branch latest vectors 1343-1, 1343-2, . . . 1343-M represents the values of the decision variables included in the branch decision variable set 1321-m at the m^{th} branch instance 132-m among the latest values of the multiple decision variables.

The main problem best vector 135 is the best main problem candidate vector 136 of the main problem candidate vectors 136 that are generated in multiple iterations.

The main problem best vector 135 includes a trunk best vector 1351, a common best vector 1352, and M branch best vectors 1353-1, 1353-2, . . . , 1353-M. The trunk best vector 1351 represents the values of the decision variables included in the trunk decision variable set 1311 among the latest values of the multiple decision variables. The common best vector 1352 represents the values of the decision variables included in the common decision variable set 133 among the latest values of the multiple decision variables. The m^{th} branch best vector 1353-m of the M branch best vectors 1353-1, 1353-2, . . . , 1353-M represents the values of the decision variables included in the branch decision variable set 1321-m at the m^{th} branch instance 132-m among the latest values of the multiple decision variables.

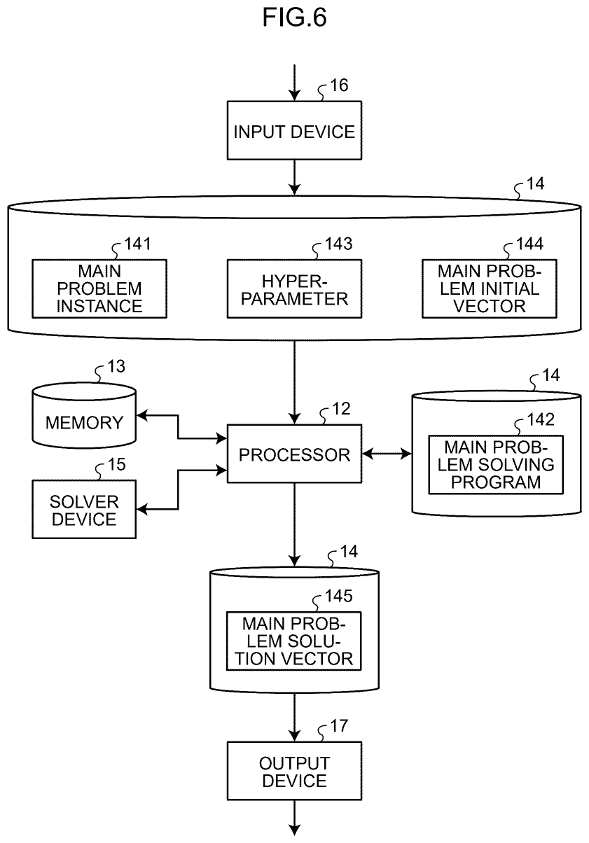

FIG. 6 is a diagram illustrating the process flow

of the problem solving device 1.

The input device 16 acquires the main problem instance 141, the hyperparameter 143, and the main problem initial vector 144 from an external device, and stores them in the storage device 14. The input device 16 may receive the main problem instance 141, the hyperparameter 143, and the main problem initial vector 144 from a user.

Subsequently, the processor 12 reads the main problem solving program 142 stored beforehand in the storage device 14, and executes the read main problem solving program 142. By executing the main problem solving program 142, the processor 12 reads the main problem instance 141, the hyperparameter 143, and the main problem initial vector 144 stored in the storage device 14 and performs data processing by using the memory 13 and the solver device 15. The processor 12 performs the data processing to generate the main problem solution vector 145, and stores the generated main problem solution vector 145 in the storage device 14. Subsequently, the output device 17 outputs the main problem solution vector 145 stored in the storage device 14 to an external device. For example, the output device 17 displays the main problem solution vector 145 stored in the storage device 14 on a display device.

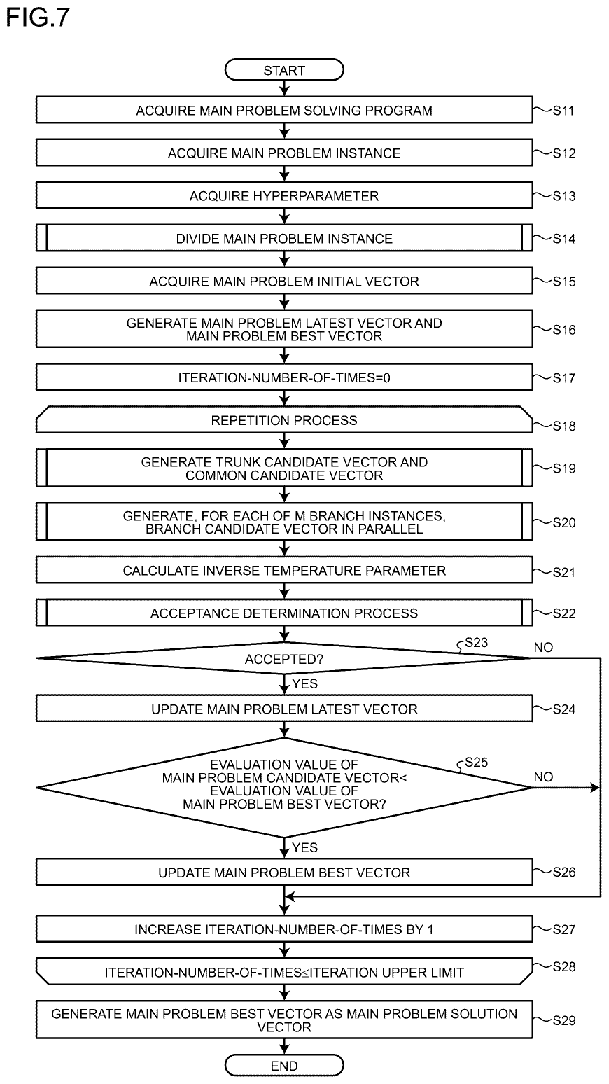

FIG. 7 is a flowchart indicating the flow of the main process by the processor 12.

First, at S11, the processor 12 acquires the main problem solving program 142 from the storage device 14. The processor 12 starts to execute the main program 1420 of the main problem solving program 142. The processor 12 continues the process after S12 by executing the main program 1420.

Subsequently, at S12, the processor 12 acquires the main problem instance 141 from the storage device 14.

Subsequently, at S13, the processor 12 acquires the hyperparameter 143 from the storage device 14.

Subsequently, at S14, the processor 12 exclusively divides each of the multiple terms included in the main problem objective function 1412 and the main problem constraint set 1413 in the main problem instance 141 to generate the trunk instance 131, the M branch instances 132-1, 132-2, . . . , 132-M, and the common decision variable set 133.

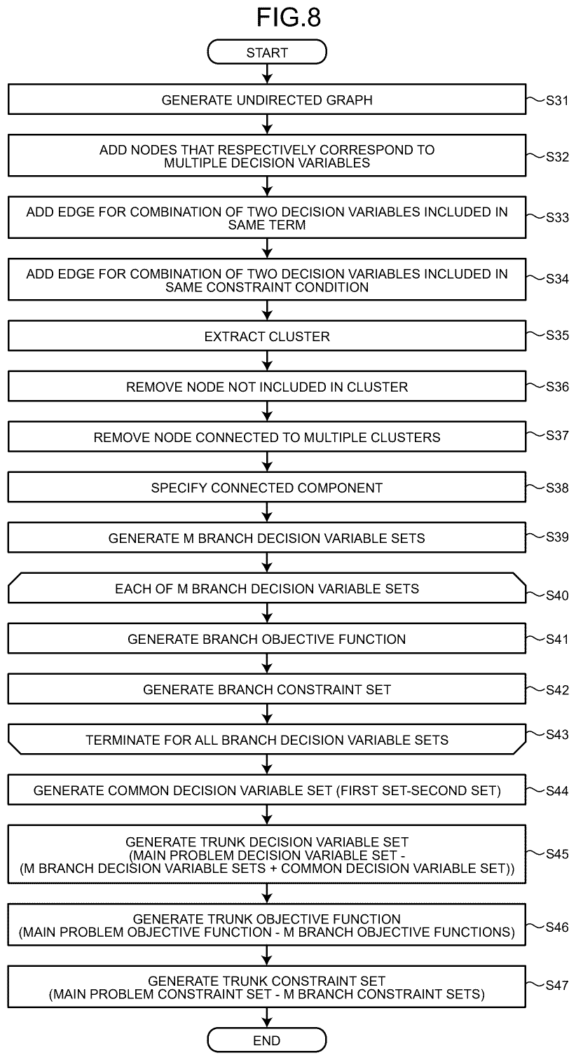

The processor 12 performs the process of S14 by executing the problem division subroutine 1421 included in the main problem solving program 142. Details of the process of the processor 12 at S14 are described later with reference to FIG. 8.

Subsequently, at S15, the processor 12 acquires the main problem initial vector 144 from the storage device 14.

Subsequently, at S16, the processor 12 generates the main problem latest vector 134 and the main problem best vector 135 based on the main problem initial vector 144. For example, the processor 12 updates each of the main problem latest vector 134 and the main problem best vector 135 with the main problem initial vector 144.

Subsequently, at S17, the processor 12 initializes the iteration-number-of-times 137 to 0.

Subsequently, the processor 12 repeats the process from S19 to S27 (loop process between S18 and S28) until the iteration-number-of-times 137 is greater than the iteration upper limit 1434.

At S19, the processor 12 generates, based on the main problem latest vector 134 and the neighborhood generation rule 1433, the trunk candidate vector 1361 representing the values of the decision variables included in the trunk instance 131 and the common candidate vector 1362 representing the values of the decision variables included in the common decision variable set 133, under the conditions satisfying the constraint conditions included in the trunk constraint set 1313. At S19, the processor 12 changes the trunk candidate vector 1361 and the common candidate vector 1362 at each iteration (loop process between S18 and S28) under the conditions satisfying the constraint conditions included in the trunk constraint set 1313.

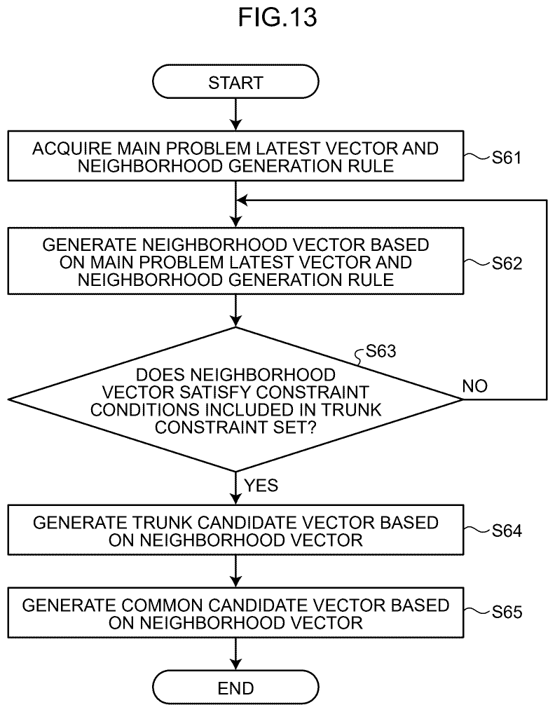

The processor 12 performs the process of S19 by executing the trunk candidate generation subroutine 1422 included in the main problem solving program 142. Details of the process of the processor 12 at S19 are described later with reference to FIG. 13.

Subsequently, at S20, the processor 12 generates, for each of the M branch instances 132-1, 132-2, . . . , 132-M, the branch candidate vector 1363 representing the solution that minimizes the branch objective function 1322, under constraints imposed by the constraint conditions included in the branch constraint set 1323 and constraints that fix the values of the decision variables included in the common decision variable set 133 to the values included in the common candidate vector 1362.

For example, by using the solver device 15, the processor 12 solves, for each of the M branch instances 132-1, 132-2, . . . , 132-M, in parallel the solution that minimizes the branch objective function 1322, under constraints imposed by the constraint conditions included in the trunk constraint set 1313.

By using the solver device 15, the processor 12 may sequentially solve, for each of the M branch instances 132-1, 132-2, . . . , 132-M, the solution that minimizes the branch objective function 1322 one by one or by a predetermined number of solutions, under the constraints imposed by the constraint conditions included in the trunk constraint set 1313.

For example, when the solver device 15 is able to calculate a solution within the processing time upper limit 1432 representing a predetermined time, the processor 12 uses the solution calculated by the solver device 15 as the branch candidate vector 1363. When the solver device 15 is unable to calculate the solution within the processing time upper limit 1432, the processor 12 uses a corresponding element in the main problem latest vector 134 as the branch candidate vector 1363. For example, when the solver device 15 is able to calculate the solution for the m^{th} branch instance 132-m within the processing time upper limit 1432, the processor 12 uses the solution calculated by the solver device 15 as the branch candidate vector 1363-m. When the solver device 15 is unable to calculate the solution within the processing time upper limit 1432, the processor 12 uses the branch latest vector 1343-m as the branch candidate vector 1363-m.

The processor 12 can generate the main problem candidate vector 136 in the current iteration by performing S20. The main problem candidate vector 136 in the current iteration includes the trunk candidate vector 1361 generated at S19, the common candidate vector 1362 generated at S19, and the branch candidate vector 1363 of each of the M branch instances 132-1, 132-2, . . . , 132-M generated at S20.

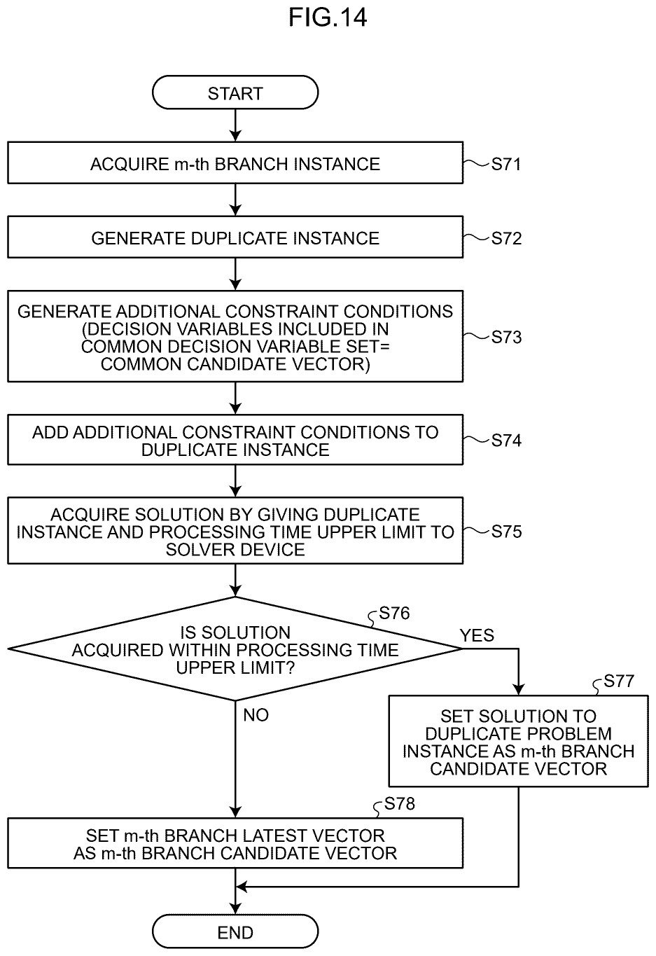

The processor 12 performs the process of S20 by executing the M branch solving subroutines 1423-1, 1423-2, . . . , 1423-M included in the main problem solving program 142 in parallel or sequentially. Details of the process of the processor 12 at S20 are described later with reference to FIG. 14.

Subsequently, at S21, the processor 12 calculates the inverse temperature parameter 138 based on the inverse temperature schedule 1435 and the iteration-number-of-times 137. The inverse temperature schedule 1435 is an arithmetic expression, a table, or the like for calculating the inverse temperature parameter 138 based on the iteration-number-of-times 137.

Subsequently, at S22, the processor 12 performs an acceptance determination process of determining whether to accept the main problem candidate vector 136 calculated in the current iteration.

When an evaluation value of the main problem candidate vector 136 in the current iteration is the same as or better than an evaluation value of the main problem latest vector 134, the processor 12 determines to accept the main problem candidate vector 136. The processor 12 calculates the evaluation value by substituting the main problem candidate vector 136 or the main problem latest vector 134 into the main problem objective function 1412. In the present embodiment, the smaller the evaluation value, the better the solution to the main problem instance 141. Accordingly, when the evaluation value of the main problem candidate vector 136 is equal to or less than the evaluation value of the main problem latest vector 134, the processor 12 determines to accept results in the current iteration.

Even when the evaluation value of the main problem candidate vector 136 in the current iteration is not better than the evaluation value of the main problem latest vector 134, the processor 12 determines whether to accept the results in the current iteration with a probability determined by the difference between the evaluation value of the main problem candidate vector 136 and the evaluation value of the main problem latest vector 134 and the inverse temperature parameter 138. Subsequently, the processor 12 generates the acceptance determination result 139 indicating acceptance or non-acceptance.

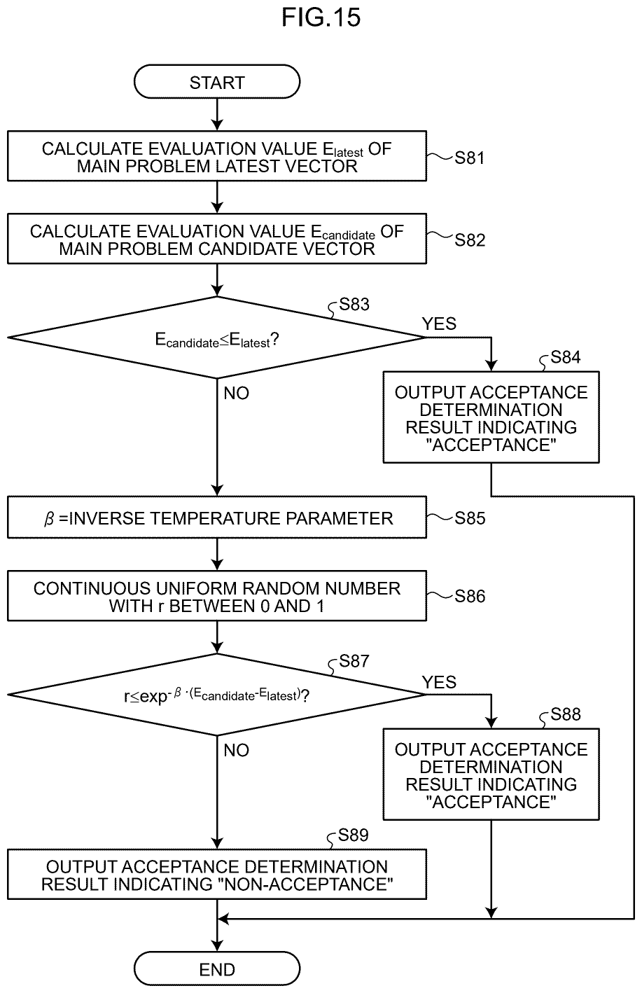

The processor 12 performs the process of S22 by executing the acceptance determination subroutine 1424. Details of the process of the processor 12 at S22 are described later with reference to FIG. 15.

Subsequently, at S23, the processor 12 determines whether the acceptance determination result 139 indicates acceptance. When the acceptance determination result 139 indicates acceptance (Yes at S23), the processor 12 proceeds to S24. When the acceptance determination result 139 indicates non-acceptance (No at S23), the processor 12 proceeds to S27.

At S24, the processor 12 updates the main problem latest vector 134 with the main problem candidate vector 136.

Subsequently, at S25, the processor 12 determines whether the evaluation value of the main problem candidate vector 136 is better than an evaluation value of the main problem best vector 135. In the present embodiment, the processor 12 determines whether the evaluation value of the main problem candidate vector 136 is smaller than the evaluation value of the main problem best vector 135.

When the evaluation value of the main problem candidate vector 136 is better than the evaluation value of the main problem best vector 135 (Yes at S25), the processor 12 proceeds to S26. When the evaluation value of the main problem candidate vector 136 is the same as or better than the evaluation value of the main problem best vector 135 (No at S25), the processor 12 proceeds to S27.

At S26, the processor 12 updates the main problem best vector 135 with the main problem candidate vector 136. The processor 12 proceeds to S27 after completing S26.

At S27, the processor 12 increases the iteration-number-of-times 137 by 1.

When the iteration-number-of-times 137 is greater than the iteration upper limit 1434, the processor 12 terminates the iteration (loop process between S18 and S28) and proceeds to S29.

The processor 12 may terminate the iteration when other termination conditions are reached. The processor 12 may, for example, terminate the iteration when the evaluation value of the main problem candidate vector 136 is equal to or less than a preset value or when the processing time is equal to or greater than a preset time.

At S29, the processor 12 generates the main problem best vector 135 as the main problem solution vector 145, and stores the generated main problem solution vector 145 in the storage device 14. Subsequently, the processor 12 terminates the present flow after completing the process of S29.

By performing the above procedure, the processor 12 can generate, as the main problem solution vector 145, the values of the multiple decision variables included in the main problem decision variable set 1411 that minimize the main problem objective function 1412 included in the main problem instance 141, under the constraints imposed by the constraint conditions included in the main problem constraint set 1413.

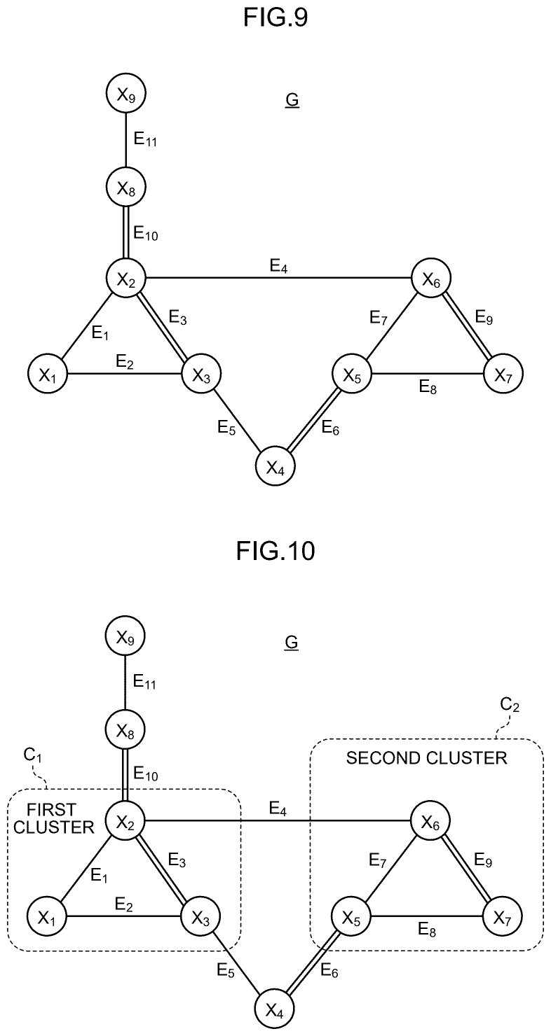

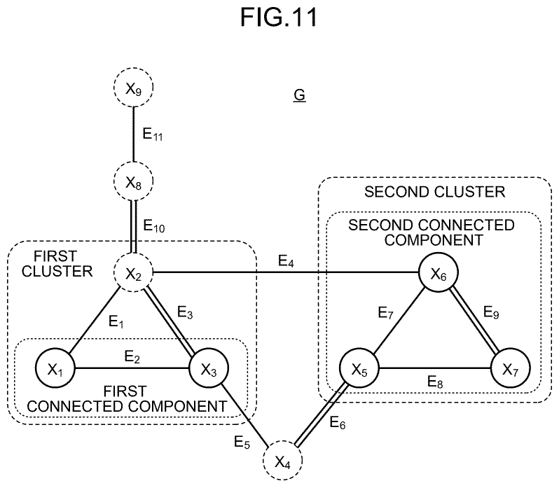

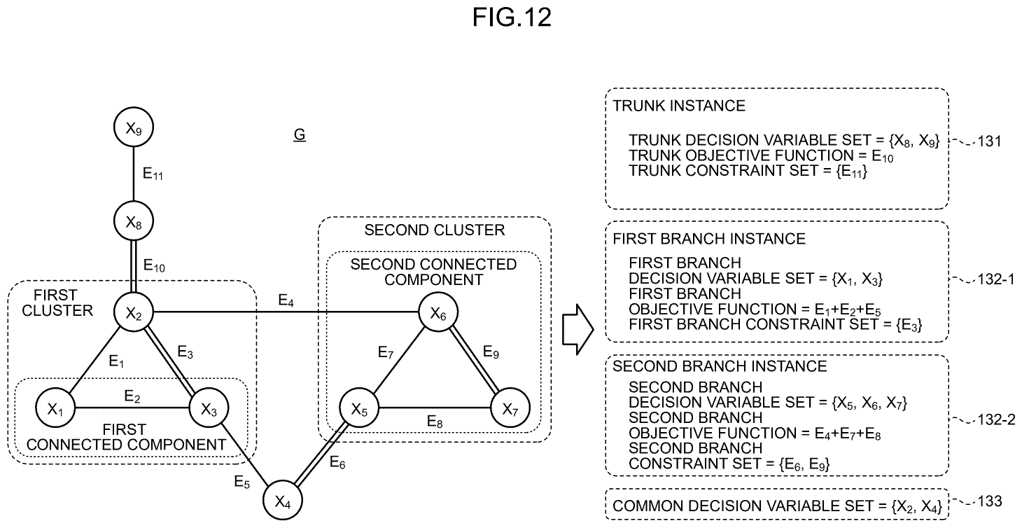

FIG. 8 is a flowchart indicating the flow of the division process for the main problem instance 141 at S14. In the explanation of the flowchart in FIG. 8, FIGS. 9, 10, 11, and 12 are referenced. FIG. 9 is a diagram illustrating an undirected graph G. FIG. 10 is a diagram illustrating a clustered undirected graph G. FIG. 11 is a diagram illustrating an undirected graph G with some of nodes removed. FIG. 12 is a diagram illustrating the relationship among the undirected graph G, the trunk instance 131, the M branch instances 132-1 and 132-2, and the common decision variable set 133.

At S14, the processor 12 performs the process illustrated in FIG. 8.

First, at S31, the processor 12 generates an undirected graph G corresponding to the main problem instance 141. Note that at this point, the undirected graph G includes no nodes and edges.

Subsequently, at S32, the processor 12 adds, to the undirected graph G, multiple nodes that correspond one-to-one to the multiple decision variables included in the main problem decision variable set 1411.

Subsequently, at S33, for each combination of two decision variables included in the same term in the main problem objective function 1412, the processor 12 adds, to the undirected graph G, edges that associate the two corresponding decision variables. The edges may be weighted edges including weights according to the coefficients of the term, for example.

Subsequently, at S34, for each combination of two decision variables included in the same constraint conditions in the main problem constraint set 1413, the processor 12 adds, to the undirected graph G, edges that associate the corresponding two decision variables. The edges may be weighted edges including weights according to a penalty given to the constraint conditions, for example.

The processor 12 may perform the processes of S33 and S34 in reverse or in parallel.

By performing the processes from S31 to S34, the processor 12 can generate the undirected graph G as illustrated in FIG. 9, for example. The undirected graph G in FIG. 9 includes 9 nodes X₁ to X₀ and 11 edges E₁ to E₁₁. The edges E₁, E₂, E₄, E₅, E₇, E₈, and E₁₁ indicated by single lines among the 11 edges correspond to a set of two decision variables included in the same term in the main problem objective function 1412. The edges E₃, E₆ E₉, and E₁₀ indicated by double lines among the nine edges correspond to a set of two decision variables included in the same constraint conditions in the main problem constraint set 1413.

Subsequently, at S35, the processor 12 clusters multiple nodes included in the undirected graph G by graph clustering analysis. Subsequently, the processor 12 extracts multiple clusters from the undirected graph G. In this case, the processor 12 extracts the multiple clusters such that the number of nodes in each of the multiple clusters is equal to or less than the size upper limit 1431. For example, the processor 12 can cluster the multiple nodes by using the clustering analysis disclosed in P Xu, X., Yuruk, N., Feng, Z. and Schweiger, T. A., “Scan: a structural clustering algorithm for networks”, August 2007, In Proceedings of the 13^{th} ACM SIGKDD international conference on Knowledge discovery and data mining, pp. 824-833, and Hiroaki Shiokawa, Yasuhiro Fujiwara, Makoto Onizuka, “Faster Graph Clustering Based on Structural Similarity,” in DEIM2014 (The 6^{th} Forum on Data Engineering and Information Management), 2014.

For example, the undirected graph G in FIG. 10 includes two clusters C₁ and C₂. A first cluster C₁ includes the nodes X₁, X₂, and X₃. A second cluster C₂ includes the nodes X₅, X₆, and X₇. The nodes X₄, X₅, and X₉ are not included in any cluster.

Subsequently, at S36, the processor 12 removes, from the undirected graph G, nodes not included in any of the multiple clusters. For example, in the case of the undirected graph G in FIG. 10, the processor 12 removes the nodes X₄, X₈, and X₉.

Subsequently, at S37, the processor 12 removes any node from the undirected graph G such that there are no more nodes connected to multiple clusters. For example, in the case of the undirected graph G in FIG. 10, the processor 12 removes the node X₂.

Note that the processor 12 does not remove nodes that were originally connected to multiple clusters but are no longer connected to multiple clusters as a result of the removal of other nodes. For example, in the undirected graph G in FIG. 10, the node X₆ is connected to multiple clusters before the node X₂ is removed. However, the node X₆ is no longer be connected to multiple clusters when the node X₂ is removed. Accordingly, when the node X₂ is removed in the undirected graph G in FIG. 10, the processor 12 does not remove the node X₆.

For example, the processor 12 can perform the process of S36 by solving the problem in Equation (1).

$${minimize}_{X} {\sum }_{i ∈ Nodes} {X}_{i} \qquad ( 1 )$$

subject to
Xᵢ∈{0,1} for ∀i∈Nodes
Cᵢ≠Cⱼ→Sᵢ+Xⱼ≥1 for ∀(i,j)∈Edges

In Equation (1) above, Nodes represents a set of nodes in the undirected graph G. Edges represent a set of edges in the undirected graph G. i and j are one or more integers that identify nodes. Cᵢ represents a cluster to which an i^{th} node belongs. Cⱼ represents a cluster to which a j^{th} node belongs. Xᵢ represents a decision variable corresponding to the i^{th} node. Xⱼ represents a decision variable corresponding to the j^{th} node.

Subsequently, the processor 12 does not remove a node corresponding to Xᵢ=0 and removes a node corresponding to Xᵢ=1 in the solution that solves the problem in Equation (1) above. This allows the processor 12 to remove nodes from the undirected graph G such that there are no nodes connected to multiple clusters.

Subsequently, at S38, the processor 12 specifies all connected components included in the undirected graph G. The connected component is a subset of the undirected graph G, a set of nodes in a relation that can be traced via edges, and is maximal. The undirected graph G includes multiple connected components as a result of the clustering at S35 and the removal of nodes at S36 and S37. For example, in FIG. 11, the undirected graph G includes a first connected component including two nodes corresponding to X₁ and X₃, and a second connected component including three nodes corresponding to X₅, X₆ and X₇.

Subsequently, at S39, the processor 12 sets the number of the specified multiple connected components to M, and generates the M branch decision variable sets 1321-1, 1321-2, . . . , 1321-M corresponding one-to-one to the multiple connected components. Each of the M branch decision variable sets 1321-1, 1321-2, . . . , 1321-M includes decision variables corresponding to nodes belonging to corresponding connected components. For example, in FIG. 11, the processor 12 generates a first branch decision variable set 1321-1 including decision variables of X₁ and X₃, and a second branch decision variable set 1321-2 including decision variables of X₅, X₆, and X₇.

Subsequently, the processor 12 performs the processes of S41 and S42 on each of the M branch decision variable sets 1321-1, 1321-2, . . . , 1321-M (loop process between S40 and S43).

At S41, for the m^{th} branch decision variable set 1321-m, the processor 12 extracts all terms including the decision variables in the m^{th} branch decision variable set 1321-m from the multiple terms included in the main problem objective function 1412. Subsequently, the processor 12 generates, as the m^{th} branch objective function 1322-m, a polynomial obtained by adding up the extracted terms.

For example, in FIG. 12, the processor 12 generates, as the first branch objective function 1322-1, a polynomial obtained by adding up a term corresponding to E₁, a term corresponding to E₂, and a term corresponding to E₅. For example, in FIG. 12, the processor 12 generates, as the second branch objective function 1322-2, a polynomial obtained by adding up a term corresponding to E₄, a term corresponding to E₇, and a term corresponding to E₈.

At S42, for the m^{th} branch decision variable set 1321-m, the processor 12 extracts all constraint conditions including the decision variables included in the m^{th} branch decision variable set 1321-m from the constraint conditions included in the main problem constraint set 1413. Subsequently, the processor 12 generates, as the m^{th} branch constraint set 1323-m, a set including the extracted constraint conditions.

For example, in FIG. 12, the processor 12 generates, as the first branch constraint set 1323-1, a set including constraint conditions corresponding to E₃. For example, in FIG. 12, the processor 12 generates, as the second branch constraint set 1323-2, a set including constraint conditions corresponding to E₆ and constraint conditions corresponding to E₉.

By performing the processes of S39 to S43, the processor 12 can generate the M branch instances 132-1, 132-2, . . . , 132-M each including the branch decision variable set 1321, the branch objective function 1322, and the branch constraint set 1323.

When the processor 12 terminates the processes of S41 and S42 on all the M branch decision variable sets 1321-1, 1321-2, . . . , 1321-M, the processor 12 proceeds to S44 (loop process between S40 and S43).

At S44, the processor 12 generates the common decision variable set 133. Specifically, the processor 12 generates the first set including all the decision variables included in the M branch objective functions 1322-1, 1322-2, . . . , 1322-M and the M branch constraint sets 1323-1, 1323-2, . . . , 1323-M. Moreover, the processor 12 generates the second set including the decision variables included in the M branch decision variable sets 1321-1, 1321-2, . . . , 1321-M. Subsequently, the processor 12 generates, as the common decision variable set 133, a set obtained by excluding the decision variables included in the second set from the decision variables included in the first set. In FIG. 12, the processor 12 generates, as the common decision variable set 133, a set including decision variables of X₂ and X₄.

Subsequently, at S45, the processor 12 generates, as the trunk decision variable set 1311, a set obtained by excluding the decision variables included in the second set (decision variables included in the M branch decision variable sets 1321-1, 1321-2, . . . , 1321-M) and the decision variables included in the common decision variable set 133 from the decision variables included in the main problem decision variable set 1411. In FIG. 12, the processor 12 generates, as the trunk decision variable set 1311, a set including decision variables of X₈ and X₉.

Subsequently, at S46, the processor 12 generates, as the trunk objective function 1312, a polynomial obtained by adding up terms excluding the terms included in the M branch objective functions 1322-1, 1322-2, . . . , 1322-M from the terms included in the main problem objective function 1412. In FIG. 12, the processor 12 generates, as the trunk objective function 1312, an equation represented by a term corresponding to E₁₀.

Subsequently, at S47, the processor 12 generates, as the trunk constraint set 1313, a set including constraint conditions excluding the constraint conditions included in the M branch constraint sets 1323-1, 1323-2, . . . , 1323-M from the constraint conditions included in the main problem constraint set 1413. In FIG. 12, the processor 12 generates, as the trunk constraint set 1313, a set including constraint conditions corresponding to E₁₁.

The processor 12 can generate the trunk instance 131 including the trunk decision variable set 1311, the trunk objective function 1312, and the trunk constraint set 1313 by performing the processes of S45 to S47.

The processor 12 terminates the present flow after completing the process of S47.

By performing the above procedure, the processor 12 can exclusively divide each of the multiple terms included in the main problem objective function 1412 and the main problem constraint set 1413 in the main problem instance 141 to generate the trunk instance 131, the M branch instances 132-1, 132-2, . . . , 132-M, and the common decision variable set 133.

In addition, since the processor 12 extracts multiple clusters such that the number of nodes included in each of the multiple clusters is equal to or less than the size upper limit 1431, the number of decision variables included in each of the M branch instances 132 can be equal to or less than the size upper limit 1431.

FIG. 13 is a flowchart indicating the flow of the process of generating the trunk candidate vector 1361 and the common candidate vector 1362 at S19.

The processor 12 performs the process at $19 with the flow illustrated in FIG. 13.

First, at S61, the processor 12 acquires the main problem latest vector 134 and the neighborhood generation rule 1433.

The neighborhood generation rule 1433 is a rule for generating a neighborhood vector representing values in the neighborhood of the main problem latest vector 134 by changing the values included in the main problem latest vector 134. For example, the neighborhood generation rule 1433 is a rule that changes the values of elements corresponding to the decision variables included in the trunk decision variable set 1311 and the common decision variable set 133, in at least the main problem latest vector 134.

Subsequently, at S62, the processor 12 generates a neighborhood vector by changing the values of elements included in the main problem latest vector 134 based on the neighborhood generation rule 1433.

Subsequently, at S63, the processor 12 determines whether the neighborhood vector satisfies the constraint conditions included in the trunk constraint set 1313. When the neighborhood vector does not satisfy the constraint conditions (No at S63), the processor 12 returns the process to S62 and generates a new neighborhood vector. When the neighborhood vector satisfies the constraint conditions (Yes at S63), the processor 12 proceeds to S64. That is, at S62 and S63, the processor 12 generates a neighborhood vector satisfying the constraint conditions included in the trunk constraint set 1313 by changing the values of some elements from the main problem latest vector 134.

At S64, the processor 12 generates the trunk candidate vector 1361 based on the values of elements corresponding to the decision variables included in the trunk decision variable set 1311 in the neighborhood vector.

Subsequently, at S65, the processor 12 generates the common candidate vector 1362 based on the values of elements corresponding to the decision variables included in the common decision variable set 133 in the neighborhood vector.

The processor 12 terminates the present flow after completing the process of S65.

By performing the above procedure, the processor 12 can change the trunk candidate vector 1361 and the common candidate vector 1362 for each iteration under the conditions satisfying the constraint conditions included in the trunk constraint set 1313.

FIG. 14 is a flowchart indicating the flow of the process of solving the m^{th} branch instance 132-m at S20.

At S20, the processor 12 performs the process in the flow illustrated in FIG. 14 on the m^{th} branch instance 132-m.

First, at S71, the processor 12 acquires the m^{th} branch instance 132-m.

Subsequently, at S72, the processor 12 generates a duplicate instance that replicates the m^{th} branch instance 132-m.

Subsequently, at S73, the processor 12 generates additional constraint conditions. The additional constraint conditions are conditions that the values of the decision variables included in the common decision variable set 133 are equal to the common candidate vector 1362.

Subsequently, at S74, the processor 12 adds the additional constraint conditions to the duplicate instance.

Subsequently, at S75, the processor 12 acquires a solution to the duplicate instance by giving the duplicate instance and the processing time upper limit 1432 to the solver device 15. In this case, when the solution is foundable within the processing time upper limit 1432, the solver device 15 outputs the solution, and when the solution is not foundable within the processing time upper limit 1432, the solver device 15 outputs information indicating that the solution is not foundable.

Subsequently, at S76, the processor 12 determines whether the solution to the duplicate instance is acquirable within the processing time upper limit 1432. When the solution to the duplicate instance is acquirable within the processing time upper limit 1432 (Yes at S76), the processor 12 proceeds to S77. When the solution to the duplicate instance is not acquirable within the processing time upper limit 1432 (No at S76), the processor 12 proceeds to S78.

At S77, the processor 12 sets the acquired solution to the duplicate problem instance as the branch candidate vector 1363-m of the m^{th} branch instance 132-m.

At S78, the processor 12 sets the m^{th} branch latest vector 1343-m as the branch candidate vector 1363-m of the m^{th} branch instance 132-m.

The processor 12 terminates the present flow after completing the process of S77 or S78.

By performing the above procedure, the processor 12 can acquire, for each of the M branch instances 132-1, 132-2, . . . , 132-M, the solution that minimizes the branch objective function 1322 from the solver device 15 under the constraints imposed by the constraint conditions included in the branch constraint set 1323 and the constraints that fix the values of the decision variables included in the common decision variable set 133 to the values included in the common candidate vector 1362. When the solution is obtained from the solver device 15 within the processing time upper limit 1432, the processor 12 can use the obtained solution as the branch candidate vector 1363-m. When no solution is obtained from the solver device 15 within the processing time upper limit 1432, the processor 12 can also use the branch latest vector 1343-m as the branch candidate vector 1363-m.

FIG. 15 is a flowchart illustrating the flow of the acceptance determination process at S22.

The processor 12 performs the process at S22 with the flow illustrated in FIG. 15.

First, at S81, the processor 12 acquires the main problem latest vector 134 and calculates an evaluation value Eₗₐₜₑₛₜ of the main problem latest vector 134.

Subsequently, at S82, the processor 12 acquires the main problem candidate vector 136 and calculates an evaluation value E_{candidate} of the main problem candidate vector 136.

Subsequently, at S83, the processor 12 determines whether the evaluation value E_{candidate} of the main problem candidate vector 136 is equal to or less than the evaluation value Eₗₐₜₑₛₜ of the main problem latest vector 134. When the evaluation value E_{candidate} of the main problem candidate vector 136 is equal to or less than the evaluation value Eₗₐₜₑₛₜ of the main problem latest vector 134 (Yes at S83), the processor 12 proceeds to S84. When the evaluation value E_{candidate} of the main problem candidate vector 136 is not equal to or less than the evaluation value Eₗₐₜₑₛₜ of the main problem latest vector 134 (No at S83), the processor 12 proceeds to S85.

At S84, the processor 12 outputs an acceptance determination result indicating acceptance. The processor 12 terminates the present flow after completing the process of S84.

At S85, the processor 12 substitutes the inverse temperature parameter 138 into β.

Subsequently, at S86, the processor 12 generates a value based on a continuous uniform random number between 0 and 1, and substitutes the generated value into r.

Subsequently, at S87, the processor 12 determines whether Equation (2) below is satisfied.

$$r \leq {exp}^{- β \cdot ( {E}_{candidate} - {E}_{latest} )} \qquad ( 2 )$$

That is, the processor 12 determines whether a value, which is obtained by substituting, into an exponential function e^{x}, a value {−β·(E_{candidate}−Eₗₐₜₑₛₜ)} obtained by multiplying the difference between the evaluation value of the main problem candidate vector 136 and the evaluation value of the main problem latest vector 134 by the inverse temperature parameter 138 (β) and −1, is equal to or greater than r being a value based on the continuous uniform random number.

When Equation (2) above is satisfied (Yes at S87), the processor 12 proceeds to S88. When Equation (2) above is not satisfied (No at S87), the processor 12 proceeds to S89.

At S88, the processor 12 outputs an acceptance determination result indicating acceptance. At S89, the processor 12 outputs an acceptance determination result indicating non-acceptance.

The processor 12 terminates the present flow after completing the process of S84, S88 or S89.

By performing the above procedure, the processor 12 can determine to accept the main problem candidate vector 136 in the current iteration when the evaluation value of the main problem candidate vector 136 in the current iteration is the same as or better than the evaluation value of the main problem latest vector 134. Even when the evaluation value of the main problem candidate vector 136 in the current iteration is not better than the evaluation value of the main problem latest vector 134, the processor 12 can determine whether to accept the main problem candidate vector 136 in the current iteration with a probability determined by the inverse temperature parameter 138 and the difference between the evaluation value of the main problem candidate vector 136 and the evaluation value of the main problem latest vector 134.

### Problem Solving Example

A specific problem solving example using the problem solving device 1 according to the first embodiment is described below. In the present problem solving example, the problem solving device 1 solves the main problem instance 141 that connects two maximum cut problems with constraint conditions.

The decision variables included in the main problem decision variable set 1411 in the main problem instance 141 are expressed by Equation (3) below. Note that N represents a problem size. In the present example, N is 5.

$${X}_{i} ∈ \{ 0 , 1 \} for 1 \leq ∀ i \leq N \qquad ( 3 )$$

$${Y}_{i} ∈ \{ 0 , 1 \} for 1 \leq ∀ i \leq N$$

The problem of minimizing the main problem objective function 1412 in the main problem instance 141 is expressed by Equation (4) below.

$$\text{?} {\sum }_{i = 1}^{N} {\sum }_{j = 1}^{N} ( {X}_{i} {X}_{j} {Q}_{i , j} + {Y}_{i} {Y}_{j} {R}_{i , j} ) \qquad ( 4 )$$

$$\text{?} \text{indicates text missing or illegible when filed}$$

The constraint conditions included in the main problem constraint set 1413 in the main problem instance 141 are expressed by Equation (5) below.

$${X}_{1} + {Y}_{1} = 1 \qquad ( 5 )$$

Q_{i.j} represents the values of elements in row i and column j of a coefficient matrix Q and is expressed by Equation (6) below. Note that Ex represents a set of edges that associate two Xs.

$${Q}_{i , j} = \{ \begin{matrix}\vert \{ i , j \} ⋂ {E}_{X} \vert & if i \neq j \\ \begin{matrix}\frac{- 1}{2} ( \vert \{ ( i , {j}^{′} ) \vert 1 \leq ∀ {j}^{′} \leq N \} ⋂ {E}_{X} \vert + \\ \vert \{ ( {i}^{′} , j ) \vert 1 \leq ∀ {i}^{′} \leq N \} ⋂ {E}_{X} \vert\end{matrix} & if i = j\end{matrix} \qquad ( 6 )$$

$$for 1 \leq ∀ i \leq N , 1 \leq ∀ j \leq N$$

R_{i.j} represents the values of elements in row i and column j of a coefficient matrix R and is expressed by Equation (7) below. Note that E_{Y} represents a set of edges that associate two Ys.

$${R}_{i , j} = \{ \begin{matrix}\vert \{ i , j \} ⋂ \text{?} \vert & if i \neq j \\ \begin{matrix}\frac{- 1}{2} ( \vert \{ ( i , {j}^{′} ) \vert 1 \leq ∀ {j}^{′} \leq N \} ⋂ \text{?} \vert + \\ \vert \{ ( {i}^{′} , j ) \vert 1 \leq ∀ {i}^{′} \leq N \} ⋂ \text{?} \vert\end{matrix} & if i = j\end{matrix} \qquad ( 7 )$$

$$for 1 \leq ∀ i \leq N , 1 \leq ∀ j \leq N$$

$$\text{?} \text{indicates text missing or illegible when filed}$$

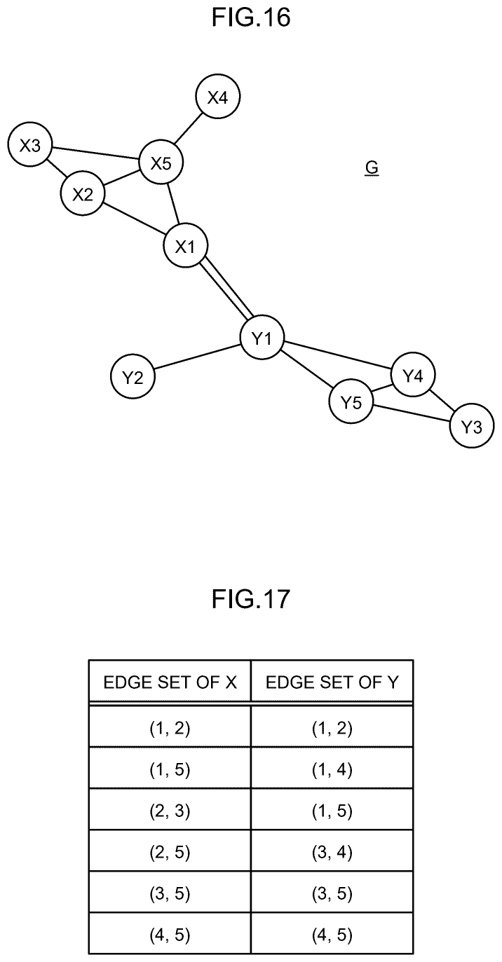

FIG. 16 is a diagram illustrating an undirected graph G of the problem solving example. FIG. 17 is a diagram illustrating a set of edges corresponding to a set of two Xs and a set of edges corresponding to a set of two Ys in the undirected graph G of the problem solving example.

An edge indicated by single lines in the undirected graph G in FIG. 16 corresponds to a set of two decision variables included in the same term in the main problem objective function 1412. An edge indicated by double lines in the undirected graph G in FIG. 16 corresponds to a set of two decision variables included in the constraint conditions included in the main problem constraint set 1413.

The problem solving device 1 generates the undirected graph G as illustrated in FIGS. 16 and 17 based on the main problem instance 141 expressed by Equations (3) to (7) above.

The problem solving device 1 uses graph clustering analysis to cluster multiple nodes included in the undirected graph G illustrated in FIG. 16. In the present example, the problem solving device 1 divides the undirected graph G into a cluster including nodes corresponding to decision variables of X1 to X5 and a cluster including nodes corresponding to decision variables of Y1 to Y5.

Subsequently, the problem solving device 1 generates the trunk instance 131 and the common decision variable set 133 based on the clustering results.

In the present example, the decision variables included in the common decision variable set 133 are expressed by Equation (8) below.

$${X}_{1} ∈ \{ 0 , 1 \} \qquad ( 8 )$$

In the present example, the decision variables included in the trunk decision variable set 1311 in the trunk instance 131 are expressed by Equation (9) below. Note that φ represents an empty set.

$$ϕ \qquad ( 9 )$$

In the present example, the problem of minimizing the trunk objective function 1312 in the trunk instance 131 is expressed by Equation (10) below.

$${minimize}_{{X}_{1}} ( {X}_{1} {X}_{1} {Q}_{1 , 1} ) \qquad ( 10 )$$

In the present example, the constraint conditions included in the trunk constraint set 1313 in the trunk instance 131 are expressed by Equation (11) below.

$$ϕ \qquad ( 11 )$$

The problem solving device 1 also generates the M branch instances 132 based on the clustering results. In the present example, the problem solving device 1 generates a first branch instance 132-1 and a second branch instance 132-2 as the M branch instances 132.

In the present example, the decision variables included in the branch decision variable set 1321-1 in the first branch instance 132-1 are expressed by Equation (12) below.

$${X}_{i} ∈ \{ 0 , 1 \} for 2 \leq ∀ i$$

In the present example, the problem of minimizing the branch objective function 1322-1 in the first branch instance 132-1 is expressed by Equation (13) below.

$${minimize}_{X} {\sum }_{i = 2}^{N} {\sum }_{j = 2}^{N} ( {X}_{i} {X}_{j} {Q}_{i , j} ) + {\sum }_{j = 2}^{N} ( {\hat{X}}_{1} {X}_{j} {Q}_{1 , j} ) + {\sum }_{i = 2}^{N} ( {X}_{i} {\hat{X}}_{1} {Q}_{i , 1} ) \qquad ( 13 )$$

In the present example, the constraint conditions included in the branch constraint set 1323-1 in the first branch instance 132-1 are expressed by Equation (14) below.

$$ϕ \qquad ( 14 )$$

In the present example, the decision variables included in the branch decision variable set 1321-2 in the second branch instance 132-2 are expressed by Equation (15) below.

$${Y}_{i} ∈ \{ 0 , 1 \} for 1 \leq ∀ i \leq N \qquad ( 15 )$$

In the present example, the problem of minimizing the branch objective function 1322-2 in the second branch instance 132-2 is expressed by Equation (16) below.

$${minimize}_{Y} {\sum }_{i = 1}^{N} {\sum }_{j = 1}^{N} ( {Y}_{i} {Y}_{j} {R}_{i , j} ) \qquad ( 16 )$$

In the present example, the constraint conditions included in the branch constraint set 1323-2 in the second branch instance 132-2 are expressed by Equation (17) below.

$${X}_{1} + {Y}_{1} = 1 \qquad ( 17 )$$

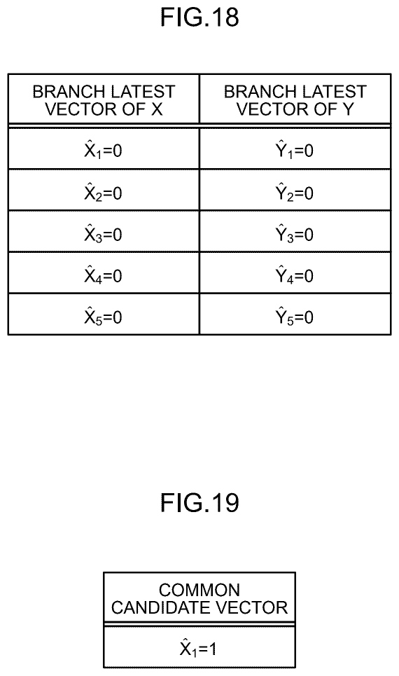

FIG. 18 is a diagram illustrating an example of the main problem latest vector 134. The problem solving device 1 generates the main problem latest vector 134. In the present example, the main problem latest vector 134 includes the branch latest vector 1343-1 corresponding to the first branch instance 132-1, and the branch latest vector 1343-2 corresponding to the second branch instance 132-2.

In the present example, the branch latest vector 1343-1 corresponding to the first branch instance 132-1 is expressed by Equation (18) below.

$${\hat{X}}_{i} for 1 \leq ∀ i \leq N \qquad ( 18 )$$

In the present example, the branch latest vector 1343-2 corresponding to the second branch instance 132-2 is expressed by Equation (19) below.

$${\hat{Y}}_{i} for 1 \leq ∀ i \leq N \qquad ( 19 )$$

FIG. 19 is a diagram illustrating an example of the common candidate vector 1362. The problem solving device 1 generates the common candidate vector 1362. The common candidate vector 1362 represents the values of the decision variables included in the main problem decision variable set 1411.

In the present example, the common candidate vector 1362 is expressed by Equation (20) below.

$${\hat{X}}_{↓} ∖ {:}_{∖}^{t} ( ( \{ 〈 . .$$

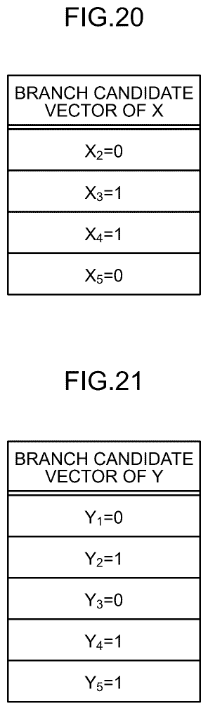

FIG. 20 is a diagram illustrating an example of the branch candidate vector 1363-1 corresponding to the first branch instance 132-1. The problem solving device 1 generates the branch candidate vector 1363-1 corresponding to the first branch instance 132-1. The branch candidate vector 1363-1 corresponding to the first branch instance 132-1 represents the values of the decision variables included in the branch decision variable set 1321-1.

In the present example, the branch candidate vector 1363-1 corresponding to the first branch instance 132-1 is expressed by Equation (21) below.

$${\hat{X}}_{1} \qquad ( 20 )$$

FIG. 21 is a diagram illustrating an example of the branch candidate vector 1363-2 corresponding to the second branch instance 132-2. The problem solving device 1 generates the branch candidate vector 1363-2 corresponding to the second branch instance 132-2. The branch candidate vector 1363-2 corresponding to the second branch instance 132-2 represents the values of the decision variables included in the branch decision variable set 1321-2.

In the present example, the branch candidate vector 1363-2 corresponding to the second branch instance 132-2 is expressed by Equation (22) below.

$${X}_{i} for 1 \leq ∀ i \leq N \qquad ( 21 )$$

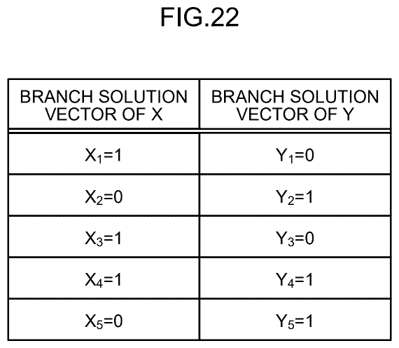

FIG. 22 is a diagram illustrating an example of the main problem solution vector 145. The problem solving device 1 generates the main problem solution vector 145. In the present example, the main problem solution vector 145 includes the branch solution vector 1453-1 corresponding to the first branch instance 132-1 and the branch solution vector 1453-2 corresponding to the second branch instance 132-2.

In the present example, the branch solution vector 1453-1 corresponding to the first branch instance 132-1 is expressed by Equation (23) below.

$${Y}_{i} for 1 \leq ∀ i \leq N \qquad ( 22 )$$

In the present example, the branch solution vector 1453-2 corresponding to the second branch instance 132-2 is expressed by Equation (24) below.

$${X}_{i} for 1 \leq ∀ i \leq N$$

### Effects

For example, sensor networks and social graphs generally have a structure including multiple clusters based on some common point, hubs that are entities connecting the multiple clusters, and outliers that do not belong to any cluster and are not hubs. Such a structure can be extracted by a graph clustering technique. In the related art, various optimization problems on the sensor networks and the social graphs have been optimized as subproblems for each of multiple clusters. However, the sensor networks and the social graphs are reticular networks in which subproblems and subproblems are connected by hubs that connect multiple clusters. Therefore, in the related art, optimization for hubs is difficult.

On the other hand, the problem solving device 1 according to the first embodiment divides the main problem instance 141 by graph clustering to generate the trunk instance 131 including decision variables corresponding to outliers, the M branch instances 132 corresponding one-to-one to multiple clusters, and the common decision variable set 133 including decision variables corresponding to hubs. Subsequently, the problem solving device 1 generates the trunk candidate vector 1361 representing the values of the decision variables included in the trunk instance 131 and a common candidate vector 1462 representing the values of the decision variables included in the common decision variable set 133. Subsequently, the problem solving device 1 generates M branch candidate vectors 1463 representing the values of the decision variables in each of the M branch instances 132 by finding a solution to each of the M branch instances 132 by fixing the common candidate vector 1462. Subsequently, the problem solving device 1 repeats the generation of the trunk candidate vector 1361 and the common candidate vector 1462 and the generation of the M branch candidate vectors 1463 to search for the best main problem candidate vector 136, and generates the main problem solution vector 145 that is a solution to the main problem instance 141.

Such a problem solving device 1 according to the first embodiment can calculate solutions to problems that include a huge number of decision variables, do not have a natural total or partial order, and have a subproblem structure in a realistic amount of time.

### SECOND EMBODIMENT

A problem solving system 3 according to a second embodiment is described below.

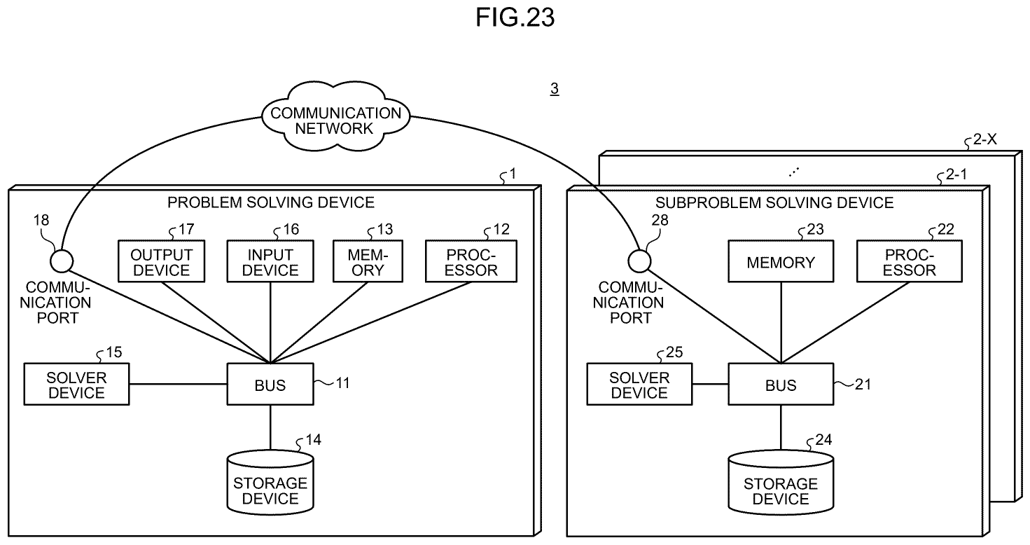

FIG. 23 is a diagram illustrating the configuration of the problem solving system 3 according to the second embodiment.

The problem solving system 3 includes a problem solving device 1 and one or more subproblem solving devices 2.

The problem solving device 1 has the same configuration as that of the first embodiment, and further includes a communication port 18. The communication port 18 is connected to the processor 12, the memory 13, the solver device 15, the storage device 14, the input device 16, and the output device 17 via the bus 11.

The communication port 18 is connected to each of the one or more subproblem solving devices 2 via a communication network. The communication port 18 transmits and receives information to and from each of the one or more subproblem solving devices 2 via the communication network.

Each of the one or more subproblem solving devices 2 includes a bus 21, a processor 22, a memory 23, a storage device 24, a solver device 25, and a communication port 28. The processor 22, the memory 23, the storage device 24, the solver device 25, and the communication port 28 are connected to one another via the bus 21.

The processor 22, the memory 23, the storage device 24, the solver device 25 of each of the one or more subproblem solving devices 2 have the same functions as those of the processor 12, the memory 13, the storage device 14, and the solver device 15 provided in the problem solving device 1 according to the first embodiment.

Each of the one or more subproblem solving devices 2 transmits and receives information via the communication network to perform some of the processes performed in the problem solving device 1 according to the first embodiment. For example, each of the one or more subproblem solving devices 2 executes some of the M branch solving subroutines 1423-1, 1423-2, . . . , 1423-M. That is, each of the one or more subproblem solving devices 2 acquires some of the M branch instances 132-1, 132-2, . . . , 132-M and the common decision variable set 133 from the problem solving device 1 via the communication network. Subsequently, each of the one or more subproblem solving devices 2 performs the process illustrated in FIG. 14 to generate the branch candidate vector 1363 that is a solution to the acquired branch instance 132. Subsequently, each of the one or more subproblem solving devices 2 transmits the branch candidate vectors 1363 to the problem solving device 1 via the communication network.

Instead of incurring additional communication overhead, such a problem solving system 3 according to the second embodiment can use multiple computer resources to calculate a solution that minimizes an objective function including a huge number of decision variables. Accordingly, the problem solving system 3 according to the second embodiment can solve problems that are difficult to solve with a single computer resource.

### THIRD EMBODIMENT

A problem solving device 1 according to a third embodiment is described below. The problem solving device 1 according to the third embodiment has the same functions and configuration as those of the first embodiment. Accordingly, a detailed description of the problem solving device 1 according to the third embodiment is omitted, except for differences from the first embodiment. The problem solving device 1 according to the third embodiment can also be applied to the problem solving system 3 according to the second embodiment.

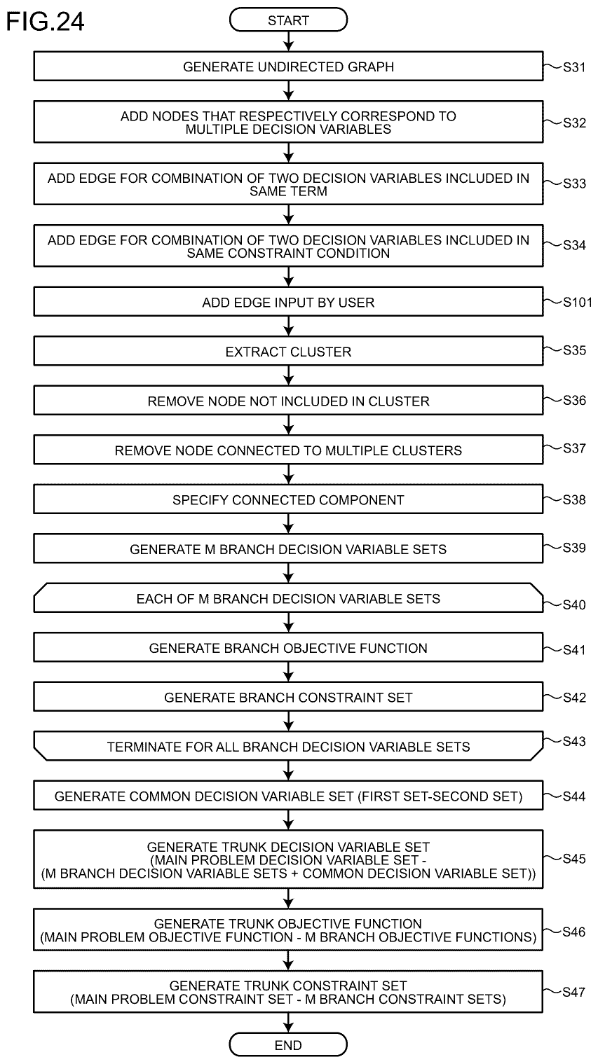

FIG. 24 is a flowchart indicating the flow of the division process for the main problem instance 141 at S14 in the third embodiment.

At S14, the processor 12 according to the third embodiment performs the process illustrated in FIG. 24. The processor 12 performs the process of S101 subsequent to S34.

At S101, the processor 12 acquires a combination of two decision variables manually input by a user and adds, to the undirected graph G, edges that associate the acquired two decision variables. In this case, the edges may be weighted edges including weights input by the user. The processor 12 may perform the process of S101 in parallel with S33 and S35. The processor 12 proceeds to S35 after completing the process of S101.

For example, the user adds edges to the undirected graph G according to his/her own knowledge such that an easy-to-solve branch instance 132 is generated. This allows the processor 12 to reduce the time for solving the branch instance 132.

In particular, when the main problem instance 141 includes a problem class that is difficult to solve, the processor 12 can significantly reduce the solving time by decomposing the main problem instance 141 into multiple branch instances 132 that are easy to solve. More specifically, for example, when the main problem instance 141 is a nonconvex quadratic programming problem, some of the branch instances 132 can be made into a first-order programming problem by adding edges to a portion of the main problem instance 141 that can be treated as a first-order programming problem when quadratic terms in an objective function are sufficiently small. In this case, the problem solving device 1 includes a solver dedicated to first-order programming problems. Subsequently, the processor 12 causes some of the branch instances 132, which are first-order programming problems, to be solved by the solver dedicated to first-order programming problems. This allows the processor 12 to significantly reduce the solving time.

### FOURTH EMBODIMENT

A problem solving device 1 according to a fourth embodiment is described below. The problem solving device 1 according to the fourth embodiment has the same functions and configuration as those of the first embodiment. Accordingly, a detailed description of the problem solving device 1 according to the fourth embodiment is omitted, except for differences from the first embodiment. The problem solving device 1 according to the fourth embodiment can also be applied to the problem solving system 3 according to the second embodiment.

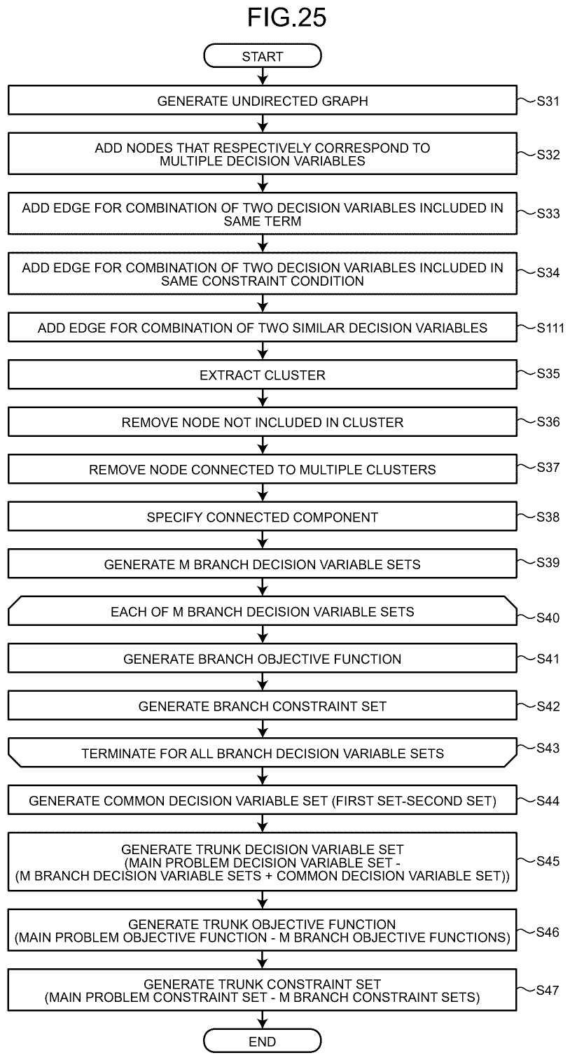

FIG. 25 is a flowchart indicating the flow of the division process for the main problem instance 141 at S14 in the fourth embodiment.

At S14, the processor 12 according to the fourth embodiment performs the process illustrated in FIG. 25. The processor 12 performs the process of S111 subsequent to S34.

At S111, the processor 12 selects a combination of two decision variables with similar variable domains among multiple decision variables. Subsequently, the processor 12 adds, to the undirected graph G, edges that associate the two decision variables included in the selected combination. In this case, the edges may be weighted edges including weights input by a user. The processor 12 may perform the process of S111 in parallel with S33 and S35. The processor 12 proceeds to S35 after completing the process of S111.

The variable domain represents the type of the decision variables or the range of values of the decision variables. For example, the variable domain varies depending on whether the decision variable takes two values of 0 and 1, or a continuous value in a given range. The variable domain may also vary depending on the content of the value represented by the decision variable. For example, when the decision variable represents a stock price, the variable domain may vary depending on the industry of the stock price represented by the decision variable, for example, shipbuilding, manufacturing industry, services, or the like.

Thus, the processor 12 utilizes the similarity of the variable domains as implicit knowledge and adds edges to the undirected graph G such that an easy-to-solve branch instance 132 is generated without receiving explicit input from a user. This allows the processor 12 to reduce the time for solving the branch instance 132 even without the user's knowledge.

For example, when the main problem instance 141 is a problem in which a continuous optimization problem and a combinatorial optimization problem are joined by constraint conditions, such a processor 12 according to the fourth embodiment can separate the main problem instance 141 by utilizing the variable domain, such that some of the branch instances 132 are continuous optimization problems and other branch instances 132 are combinatorial optimization problems. In this case, the problem solving device 1 includes a solver dedicated to the continuous optimization problems and a solver dedicated to the combinatorial optimization problems. Subsequently, the processor 12 causes some of the branch instances 132 being the continuous optimization problems to be solved by the solver dedicated to the continuous optimization problems and other branch instances 132 being the combinatorial optimization problems to be solved by the solver dedicated to the optimization problems. This allows the processor 12 to significantly reduce the solving time.

### Computer Program or the Like

The main problem solving program 142 to be executed by the problem solving device 1 is provided in an installable or executable format file on a computer-readable recording medium such as a CD-ROM, a flexible disk (FD), a CD-R, and a digital versatile disc (DVD).

The main problem solving program 142 may be configured to be provided by being stored on a computer connected to a network such as the Internet and downloaded via the network. The main problem solving program 142 may also be configured to be provided or distributed via the network such as the Internet. The main problem solving program 142 may also be configured to be provided by being pre-embedded in a ROM or the like.

For example, the problem solving device 1 may be implemented by a reconfigurable semiconductor device such as an FPGA. The problem solving device 1 may also be implemented by a CPU, a microprocessor, a GPU, and an ASIC, or an electronic circuit including these circuits. The problem solving device 1 may also be implemented by an information processing device such as a computer, a computer system in which multiple computers or servers communicate with each other via a network, a PC cluster in which multiple computers perform information processing in cooperation with each other, or the like.

When the problem solving device 1 is implemented by a reconfigurable semiconductor device such as an FPGA, circuit information (configuration data) that is written to the reconfigurable semiconductor device in order to operate the reconfigurable semiconductor device as the problem solving device 1 may be configured to be provided by being stored on a computer connected to a network such as the Internet and downloaded via the network. The circuit information (configuration data) that is written to the reconfigurable semiconductor device in order to operate the reconfigurable semiconductor device as the problem solving device 1 may also be configured to be provided by being recorded on a computer-readable recording medium.

When the problem solving device 1 is implemented by a semiconductor device such as an ASIC, circuit information representing the configuration of a circuit described in a hardware description language may be configured to be provided by being stored on a computer connected to a network such as the Internet and downloaded via a network, in order to operate the semiconductor device such as an ASIC as the problem solving device 1. In order to operate the semiconductor device such as an ASIC as the problem solving device 1, the circuit information representing the configuration of a circuit described in a hardware description language may also be configured to be provided by being recorded on a computer-readable recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A problem solving device that calculates a main problem solution vector representing a solution that minimizes a main problem objective function being a polynomial obtained by adding up multiple terms, under constraints imposed by constraint conditions included in a main problem constraint set, each of the multiple terms being an equation obtained by multiplying one or more of multiple decision variables by a coefficient, the problem solving device comprising:
a processing unit comprising a hardware processor and configured to:
acquire a main problem instance including the main problem objective function and the main problem constraint set,
generate a trunk instance and M branch instances (M is an integer equal to or greater than 2) by exclusively dividing each of the multiple terms included in the main problem objective function and the main problem constraint set, the trunk instance including a trunk objective function being an equation obtained by adding up some of the multiple terms and a trunk constraint set being a subset of the main problem constraint set, the M branch instances each including a branch objective function being an equation obtained by adding up some of the multiple terms and a branch constraint set being a subset of the main problem constraint set,
generate a common decision variable set including decision variables commonly used for the trunk instance and any two of the M branch instances,
generate a trunk candidate vector representing values of the decision variables included in the trunk instance and a common candidate vector representing values of the decision variables included in the common decision variable set,
generate, for each of the M branch instances, a branch candidate vector representing a solution that minimizes the branch objective function, under constraints imposed by constraint conditions included in the branch constraint set and constraints that fix the values of the decision variables included in the common decision variable set to values included in the common candidate vector, and
output the main problem solution vector including the trunk candidate vector and the branch candidate vector for each of the M branch instances.

2. The problem solving device according to claim 1, wherein
the main problem instance further includes a main problem decision variable set including the multiple decision variables,
each of the M branch instances further includes a branch decision variable set being a subset of the main problem decision variable set,
the branch decision variable set of an m^{th} branch instance (m is an integer equal to and greater than 1 and M or smaller) of the M branch instances includes a decision variable not included in the branch decision variable set of a branch instance different from the m^{th} branch instance of the M branch instances,
the branch objective function of the m^{th} branch instance includes terms not included in the branch objective function of a branch instance different from the m^{th} branch instance,
the branch constraint set of the m^{th} branch instance includes constraint conditions not included in the branch constraint set of a branch instance different from the m^{th} branch instance,
the trunk instance further includes a trunk decision variable set being the subset of the main problem decision variable set,
the trunk decision variable set includes decision variables excluding decision variables included in the common decision variable set and the branch decision variable set of each of the M branch instances from the decision variables of the main problem decision variable set,
the trunk objective function includes terms of the multiple terms excluding terms included in the branch objective function of each of the M branch instances, and
the trunk constraint set includes constraint conditions excluding constraint conditions included in the branch constraint set of each of the M branch instances from the constraint conditions of the main problem constraint set.

3. The problem solving device according to claim 2, wherein, for each of the M branch instances, the processing unit generates, as the branch objective function, an equation obtained by adding up terms including the decision variables included in the branch decision variable set among the multiple terms included in the main problem objective function.

4. The problem solving device according to claim 3, wherein, for each of the M branch instances, the processing unit generates, as the branch constraint set, a set including constraint conditions including the decision variables included in the branch decision variable set among the constraint conditions included in the main problem constraint set.

5. The problem solving device according to claim 4, wherein the processing unit generates, as the common decision variable set, a set excluding a second set including the decision variables included in all the branch decision variable sets of the M branch instances from a first set including the decision variables included in all the branch objective functions of the M branch instances and all the branch constraint sets of the M branch instances.

6. The problem solving device according to claim 5, wherein the processing unit generates, as the trunk decision variable set, a set excluding all the branch decision variable sets of the M branch instances and the common decision variable set from the main problem decision variable set.

7. The problem solving device according to claim 6, wherein the processing unit generates, as the trunk objective function, an equation obtained by adding up terms excluding terms included in all the branch objective functions of the M branch instances from the multiple terms included in the main problem objective function.

8. The problem solving device according to claim 7, wherein the processing unit generates, as the trunk constraint set, a set excluding all the branch constraint sets of the M branch instances from the main problem constraint set.

9. The problem solving device according to claim 2, wherein the processing unit
adds, to an undirected graph, multiple nodes corresponding one-to-one to the multiple decision variables,
adds, to the undirected graph, edges for each of a combination of two decision variables included in a same term in the main problem objective function and a combination of two decision variables included in a same constraint condition in the main problem constraint set, the edges associating the corresponding two decision variables,
clusters the undirected graph into multiple clusters by graph clustering analysis,
removes nodes not belonging to any of the multiple clusters among the multiple nodes from the undirected graph,
removes any node of the multiple nodes from the undirected graph such that nodes connected to two or more of the multiple clusters are not included,
specifies multiple connected components included in the undirected graph, and
correlates the multiple connected components to the M branch instances and includes, in the branch decision variable set of each of the M branch instances, decision variables corresponding to nodes included in the correlated connected components of the multiple connected components.

10. The problem solving device according to claim 9, wherein the processing unit clusters the undirected graph such that a number of nodes included in each of the multiple clusters is equal to or less than a preset size upper limit.

11. The problem solving device according to claim 9, wherein the processing unit adds, to the undirected graph, edges that associate a combination of two decision variables input by a user.

12. The problem solving device according to claim 9, wherein the processing unit adds, to the undirected graph, edges that associate a combination of two decision variables with similar variable domains among the multiple decision variables.

13. The problem solving device according to claim 1, wherein the processing unit
repeats, while changing the trunk candidate vector and the common candidate vector,
a process of generating the trunk candidate vector and the common candidate vector satisfying constraint conditions included in the trunk constraint set,
a process of generating, for each of the M branch instances, the branch candidate vector representing the solution that minimizes the branch objective function, under the constraints imposed by the constraint conditions included in the branch constraint set and the constraints that fix the values of the decision variables included in the common decision variable set to the values included in the branch candidate vector, and
a process of determining an evaluation value of the main problem candidate vector including the trunk candidate vector and the branch candidate vector for each of the M branch instances, and
the processing unit outputs the main problem candidate vector with a best evaluation value as the main problem solution vector.

14. The problem solving device according to claim 13, wherein, for each iteration, the processing unit
accepts the main problem candidate vector when the evaluation value of the main problem candidate vector is better than an evaluation value of a main problem latest vector being a latest main problem candidate vector,
updates the main problem latest vector by the main problem candidate vector when the main problem candidate vector is accepted,
updates a main problem best vector by the main problem latest vector when the evaluation value of the main problem candidate vector is better than an evaluation value of the main problem best vector when the main problem candidate vector is accepted, and
outputs the main problem best vector as the main problem solution vector when the iteration is executed up to a predetermined termination condition.

15. The problem solving device according to claim 14, wherein, when the evaluation value of the main problem candidate vector is not better than the evaluation value of the main problem latest vector, the processing unit accepts the main problem candidate vector with a probability determined by a predetermined inverse temperature parameter and a difference between the evaluation value of the main problem candidate vector and the evaluation value of the main problem latest vector.

16. The problem solving device according to claim 13, wherein,
for each of the M branch instances,
when a solution is calculatable within a processing time upper limit representing a predetermined time, the processing unit uses the calculated solution as the branch candidate vector, and
when the solution is not calculatable within the processing time upper limit, the processing unit uses, as the branch candidate vector, a corresponding element in a main problem latest vector being the latest main problem candidate vector.

17. The problem solving device according to claim 13, wherein the processing unit finds a solution that minimizes the branch objective function in parallel, with the M branch instances.

18. A problem solving method implemented by an information processing device to perform calculating a main problem solution vector representing a solution that minimizes a main problem objective function being a polynomial obtained by adding up multiple terms, under constraints imposed by constraint conditions included in a main problem constraint set, each of the multiple terms being an equation obtained by multiplying one or more of multiple decision variables by a coefficient, the method comprising:
acquiring a main problem instance including the main problem objective function and the main problem constraint set,
generating a trunk instance and M branch instances (M is an integer equal to or greater than 2) by exclusively dividing each of the multiple terms included in the main problem objective function and the main problem constraint set, the trunk instance including a trunk objective function being an equation obtained by adding up some of the multiple terms and a trunk constraint set being a subset of the main problem constraint set, the M branch instances each including a branch objective function being an equation obtained by adding up some of the multiple terms and a branch constraint set being a subset of the main problem constraint set,
generating a common decision variable set including decision variables commonly used for the trunk instance and any two of the M branch instances,
generating a trunk candidate vector representing values of the decision variables included in the trunk instance and a common candidate vector representing values of the decision variables included in the common decision variable set,
generating, for each of the M branch instances, a branch candidate vector representing a solution that minimizes the branch objective function, under constraints imposed by constraint conditions included in the branch constraint set and constraints that fix the values of the decision variables included in the common decision variable set to values included in the common candidate vector, and
outputting the main problem solution vector including the trunk candidate vector and the branch candidate vector for each of the M branch instances.

19. A computer program product having a non-transitory computer readable medium including programmed instructions stored thereon, wherein the instructions causing an information processing device to serve as a problem solving device that calculates a main problem solution vector representing a solution that minimizes a main problem objective function being a polynomial obtained by adding up multiple terms, under constraints imposed by constraint conditions included in a main problem constraint set, each of the multiple terms being an equation obtained by multiplying one or more of multiple decision variables by a coefficient, when executed by a computer of the information processing device, cause the information processing device to perform:
acquiring a main problem instance including the main problem objective function and the main problem constraint set,
generating a trunk instance and M branch instances (M is an integer equal to or greater than 2) by exclusively dividing each of the multiple terms included in the main problem objective function and the main problem constraint set, the trunk instance including a trunk objective function being an equation obtained by adding up some of the multiple terms and a trunk constraint set being a subset of the main problem constraint set, the M branch instances each including a branch objective function being an equation obtained by adding up some of the multiple terms and a branch constraint set being a subset of the main problem constraint set,
generating a common decision variable set including decision variables commonly used for the trunk instance and any two of the M branch instances,
generating a trunk candidate vector representing values of the decision variables included in the trunk instance and a common candidate vector representing values of the decision variables included in the common decision variable set,
generating, for each of the M branch instances, a branch candidate vector representing a solution that minimizes the branch objective function, under constraints imposed by constraint conditions included in the branch constraint set and constraints that fix the values of the decision variables included in the common decision variable set to values included in the common candidate vector, and
outputting the main problem solution vector including the trunk candidate vector and the branch candidate vector for each of the M branch instances.
